(19) United States
(12) Patent Application Publication
(10) Pub. No.: US 2025/0209783 A1
(43) Pub. Date: Jun. 26, 2025

(54) MODEL DETERMINATION METHOD AND RELATED APPARATUS

(71) Applicant: Tencent Technology (Shenzhen) Company Limited, Shenzhen (CN)

(72) Inventors: Keyue ZHANG, Shenzhen (CN); Junyi CAO, Shenzhen (CN); Taiping YAO, Shenzhen (CN); Bangjie YIN, Shenzhen (CN); Shouhong DING, Shenzhen (CN)

(73) Assignee: Tencent Technology (Shenzhen) Company Limited, Shenzhen (CN)

(21) Appl. No.: 19/078,463

(22) Filed: Mar. 13, 2025

Related U.S. Application Data
(63) Continuation of application No. PCT/CN2024/071927, filed on Jan. 12, 2024.

(30) Foreign Application Priority Data
Mar. 7, 2023 (CN) 202310260221.1

(51) Int. Cl. G06V 10/44; G06T 7/11; G06T 11/00; G06V 10/54; G06V 10/74; G06V 10/764

(52) U.S. Cl. CPC G06V 10/44; G06T 7/11; G06T 11/001; G06V 10/54; G06V 10/761; G06V 10/764; G06T 2207/20081

(57) ABSTRACT

A model determining method including obtaining a first image sample, inputting the first image sample to an initial encoder of an initial identification model to obtain a first image sample feature, generating a second image sample feature based on the first image sample feature, separately inputting the first and second image sample features to an initial decoder to obtain a first texture image and a second texture image, inputting the first image sample feature and the first texture image to an initial classifier to obtain a first prediction result, inputting the second image sample feature and the second texture image to the initial classifier to obtain a second prediction result, generating an identification loss function based on a difference between each of the first and the second prediction results and an identification tag, and training an initial identification model using the identification loss function to obtain an updated identification model.

### CROSS-REFERENCE TO RELATED APPLICATIONS

This application is a continuation application of International Application No. PCT/CN2024/071927 filed on Jan. 12, 2024, which claims priority to Chinese Patent Application No. 202310260221.1 filed with the China National Intellectual Property Administration on Mar. 7, 2023, the disclosures of each being incorporated by reference herein in their entireties.

### FIELD

The disclosure relates to the field of artificial intelligence, and in particular, to a model training technology.

### BACKGROUND

An identification model is a model for identifying a type of an object in an image. An initial identification model is trained based on a quantity of image samples, to obtain an identification model having an identification capability. The identification model may be applied to multiple aspects of production and life.

During actual application, the identification model usually encounters a plurality of identification scenes and a plurality of attack types, and may even encounter a new identification scene and a new attack type that are never encountered during training. For example, during training, the identification model is trained based on an image sample in an indoor scene, but during actual application, an identification image encountered by the identification model may be an image in an outdoor scene. In some embodiments, when the identification model is configured for identifying a living body, an attack type of an image sample used during training of the identification model is disguised from a true living body by using a photograph, but during actual application, an attack type of an identification image encountered by the identification model may be disguised from a true living body through video replay. To be specific, during actual application, the identification model encounters various identification scenes and attack types.

However, when the identification model trained in the related art identifies a type of an object in an image, facing cross-scene identification and cross-attack type identification, it is unlikely to reach a needed generalization requirement. Consequently, it is unlikely to widely apply the identification model.

### SUMMARY

Some embodiments provide a model determining method, performed by a computer device, including obtaining a first image sample, the first image sample having an identification tag identifying an object type to which an object in the first image sample belongs; inputting the first image sample to an initial encoder of an initial identification model to obtain a first image sample feature of the first image sample, the initial identification model further comprising an initial decoder and an initial classifier; generating a second image sample feature based on the first image sample feature, the second image sample feature and the first image sample feature having different scene parameter values and corresponding to the same identification tag; separately inputting the first image sample feature and the second image sample feature to the initial decoder to obtain a first texture image corresponding to the first image sample feature and a second texture image corresponding to the second image sample feature; inputting the first image sample feature and the first texture image to the initial classifier to obtain a first prediction result of the object type, and inputting the second image sample feature and the second texture image to the initial classifier to obtain a second prediction result of the object type; generating an identification loss function based on a difference between each of the first prediction result and the second prediction result and the identification tag; and training the initial identification model by using the identification loss function to obtain an updated identification model.

Some embodiments provide a model determining apparatus including at least one memory configured to store computer program code; and at least one processor configured to read the program code and operate as instructed by the program code, the program code comprising: sample obtaining code configured to cause at least one of the at least one processor to obtain a first image sample, the first image sample having an identification tag identifying an object type to which an object in the first image sample belongs; first determining code configured to cause at least one of the at least one processor to input the first image sample to an initial encoder of an initial identification model to obtain a first image sample feature of the first image sample, the initial identification model further comprising an initial decoder and an initial classifier first generation code configured to cause at least one of the at least one processor to generate a second image sample feature based on the first image sample feature, the second image sample feature and the first image sample feature having different scene parameter values and corresponding to the same identification tag; texture obtaining code configured to cause at least one of the at least one processor to separately input the first image sample feature and the second image sample feature to the initial decoder to obtain a first texture image corresponding to the first image sample feature and a second texture image corresponding to the second image sample feature; second determining code configured to cause at least one of the at least one processor to input the first image sample feature and the first texture image to the initial classifier to obtain a first prediction result of the object type, and input the second image sample feature and the second texture image to the initial classifier to obtain a second prediction result of the object type; second generation code configured to cause at least one of the at least one processor to generate an identification loss function based on a difference between each of the first prediction result and the second prediction result and the identification tag; and training code configured to train the initial identification model by using the identification loss function to obtain an updated identification mode.

Some embodiments provide a computer-readable storage medium, storing computer code which, when executed by at least one processor, causes the at least one processor to at least: obtain a first image sample, the first image sample having an identification tag identifying an object type to which an object in the first image sample belongs; input the first image sample to an initial encoder of an initial identification model to obtain a first image sample feature of the first image sample, the initial identification model further comprising an initial decoder and an initial classifier; generate a second image sample feature based on the first image sample feature, the second image sample feature and the first image sample feature having different scene parameter values and corresponding to the same identification tag; separately input the first image sample feature and the second image sample feature to the initial decoder to obtain a first texture image corresponding to the first image sample feature and a second texture image corresponding to the second image sample feature; input the first image sample feature and the first texture image to the initial classifier to obtain a first prediction result of the object type, and input the second image sample feature and the second texture image to the initial classifier to obtain a second prediction result of the object type; generate an identification loss function based on a difference between each of the first prediction result and the second prediction result and the identification tag; and train the initial identification model by using the identification loss function to obtain an updated identification model.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a model determining scene according to some embodiments.

FIG. 2 is a method flowchart of a model determining method according to some embodiments.

FIG. 3 is a schematic diagram of cross-scene conversion for an image sample feature according to some embodiments.

FIG. 4 is a schematic diagram of an attention mechanism according to some embodiments.

FIG. 5 is a schematic diagram of a detail-enhanced attention mechanism according to some embodiments.

FIG. 6 is a specific schematic diagram of a model determining method according to some embodiments.

FIG. 7 is a schematic diagram of test of an identification model according to some embodiments.

FIG. 8 is a schematic diagram of an apparatus for a model determining method according to some embodiments.

FIG. 9 is a structural diagram of a terminal device according to some embodiments.

FIG. 10 is a structural diagram of a server according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

It can be seen from the foregoing technical solutions that this application provides a method for training an identification model for identifying an object type of an object in an image. A to-be-trained initial identification model includes an initial encoder, an initial decoder, and an initial classifier. In some embodiments, when the initial identification model is trained, a first image sample feature of a first image sample is first determined by using the initial encoder in the initial identification model. The first image sample has an identification tag identifying an object type to which an object belongs. To improve an identification capability of the model for objects in different scene environments, in this application, a second image sample feature is generated based on the first image sample feature, where the second image sample feature and the first image sample feature have different scene parameter values but correspond to the same identification tag. For the two image sample features, corresponding texture images may be obtained by using the initial decoder, corresponding object type prediction results may be determined by using the initial classifier according to the image sample features and the corresponding texture images, and then an initial identification model is trained by using an identification loss function generated based on the identification tag and the prediction results, to obtain an updated identification model. Cross-scene conversion is performed on the first image sample feature, to obtain the second image sample feature that has a different scene parameter and the same identification tag as the first image sample feature, so that the initial identification model may learn a capability of identifying the same object in different scene environments during training. In addition, the cross-scene conversion is directly performed on the first image sample feature, thereby avoiding encoding processing on an additional sample, and avoiding a substantial impact on model training efficiency. When an object type is predicted, in addition to the image sample features, a texture image is further introduced, and image information is more abundantly expressed from a feature dimension and a texture dimension, so that the initial identification model learns a more accurate identification capability in a training process, and can deal with more diverse attack identification means. When the identification model obtained by training performs object identification, the identification model has a good generalization capability for images having different scenes and images generated in different modes, thereby effectively improving model identification accuracy.

An identification model may be applied to multiple aspects of production and life. For example, a living body identification model in the identification model may identify whether a face in a face image is from a true living body, thereby verifying authenticity of a user. A false face attack is withheld by using the living body identification model, so as to effectively ensure security of a face identification system. To be specific, the living body identification model may be widely applied as an important part of the face identification system in production and life. For example, in a remote account opening process of a bank, a server determines a true identity of an account opener by using a face identification system, and a living body identification model is applied thereto. After a front end of an application obtains an image including a face of a user by using a camera, the front end of the application transmits the image including the face of the user to a back end and invokes the living body identification model, so as to perform living body identification. If it is determined that the face in the image is from a living body, a subsequent identity verification operation is performed; otherwise, direct identity verification fails. In a process of performing face payment by using the face identification system, the living body identification model may improve payment security, and the living body identification model may defend against some transaction attacks that cause losses to enterprises or individuals, thereby ensuring the security of the face payment. When community security is implemented by using the face identification system, after directly obtaining a face image on the front end, the face identification system may transmit the face image to the encapsulated living body identification model to directly perform determining.

An application value of the identification model is usually determined by generalization performance of the model. Higher generalization performance of the identification model indicates more application scenes of the model, and higher corresponding application value. Therefore, to ensure the application value of the identification model, it needs to ensure that the identification model has better generalization performance. In the related art, model training is mainly separately performed from two aspects to improve the generalization performance.

One aspect focuses on improving the generalization performance of the identification model facing a plurality of identification scenes. The plurality of identification scenes may further include an unknown identification scene (unknown domain), and the unknown domain includes characteristics such as different scenes, illumination, and acquisition device precision compared with training an image sample. This aspect mainly includes a technology of image classification domain generalization task. The model learns domain-unrelated features by using a policy such as domain confrontation training or meta-learning, so that the model obtains better generalization performance on the unknown domain. For example, for a living body identification model, a single-side domain generalization for face anti-spoofing (SSDG) algorithm exists in the related art. The algorithm uses a domain discriminator to discriminate living body face features that are extracted by a feature extractor from different domains. When the living body face features extracted by the feature extractor can well be identified by the domain discriminator as a living body face, the features are considered as cross-domain irrelevant features. Therefore, the features may have a good identification capability on the unknown domain.

Another aspect focuses on improving a detection capability of the identification model when facing a plurality of attack types, and in particular, facing a new attack type. For example, for the living body identification model, the attack types include various attack types that may provide a false face, such as a photo, a video, a face swapper, and a mask. The new attack type includes an attack type that does not appear in training image samples. In this aspect, the generalization performance of the model facing the new attack type is improved mainly by using a zero-sample learning or abnormality detection policy, so that the model learning may be generalized to an attack clue of the new attack type. For example, for the living body identification model, a deep tree learning for zero-shot face anti-spoofing (DTN) algorithm exists in the related art. The algorithm uses a zero-sample learning method. A known attack type is divided into several clusters according to semantics, and binary classification living body detection is performed in each cluster. In the face of a new attack type, an image of the new attack type is routed to a most similar cluster for binary classification, thereby improving the generalization capability of the living body identification model facing the new attack type.

However, when the identification model trained in the related art identifies a type of an object in an image during actual application, an identification scene change and a new attack type may exist at the same time. For example, the trained living body identification model is attacked by using a photo in an indoor scene, and may encounter a video replay attack in an outdoor scene during actual application. To be specific, the identification model may face a plurality of new identification scenes and new attack types, and even may encounter an unknown identification scene and new attack type at the same time. In this case, it is difficult for the model trained in the related art to reach a needed generalization requirement.

Therefore, some embodiments provide a model determining method and a related apparatus. In a training process, not only a capability of identifying the same object in different identification environments by an identification model is improved, but also the model learns a more accurate identification capability in the training process, so as to effectively defend against various attack types, thereby obtaining an identification model having a better generalization capability for cross-scene identification and cross-attack type identification.

The model determining method provided in some embodiments may be implemented by using a computer device. The computer device may be a terminal device or a server. The server may be an independent physical server, may be a server cluster or a distributed system including a plurality of physical servers, or may be a cloud server providing a cloud computing service. The terminal device includes but is not limited to a mobile phone, a computer, an intelligent voice interaction device, a smart home appliance, an in-vehicle terminal, an aircraft, and the like. The terminal device and the server may be directly or indirectly connected in a wired or wireless communication protocol. This is not limited in this application.

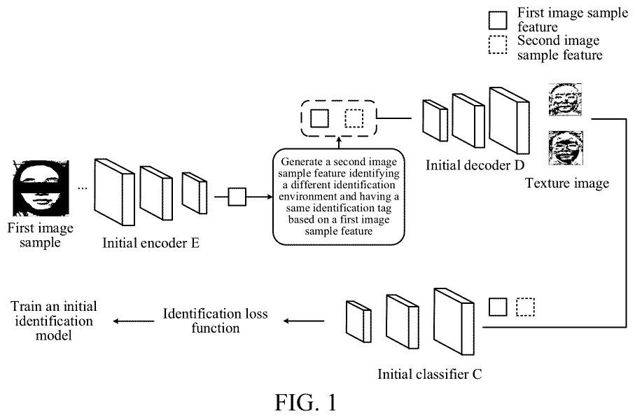

FIG. 1 is a schematic diagram of an application scene of a model determining method according to some embodiments. The foregoing computer device is a server.

An identification model is a model for identifying a type of an object in an image. The identification model may be obtained by training and optimizing an initial identification model. During actual application, the identification model encounters a plurality of identification scenes and a plurality of attack types, and even encounters an unknown identification scene and a new attack type that are not encountered in a training process. However, when an identification model trained in the related art identifies an object type, it is unlikely to reach a required generalization requirement when facing cross-scene identification and cross-attack type identification, thereby reducing an application value of the identification model.

In view of this, in an application scene of some embodiments, a to-be-trained initial identification model includes an initial encoder E, an initial decoder D, and an initial classifier C. As shown in FIG. 1, the initial encoder E may obtain, from an image sample, an image feature that can reflect image information in a feature dimension. The initial decoder D may generate, according to the image feature, a texture image that can reflect the image information in a texture dimension. The initial classifier C may comprehensively identify an image according to the image feature and the texture image.

In some embodiments, the server may input a first image sample to the initial encoder, to obtain a corresponding first image sample feature. In addition, to improve an identification capability of the model in different identification scenes, the server generates a second image sample feature based on the first image sample feature. The first image sample feature and the second image sample feature identify different scene environments but have the same identification tag. For the two image sample features, corresponding texture images may be obtained by using the initial decoder, corresponding object type prediction results may be determined by using the initial classifier according to the image sample feature and the corresponding texture images, and an initial identification model is trained by using an identification loss function generated based on the object type prediction results and the identification tag, to obtain an identification model. The second image sample feature identifying a different identification environment but having the same identification tag as the first image sample feature is generated based on the first image sample feature, and the two image sample features are both used for training the initial identification model, so that a capability of identifying the same object in different identification environments by the model can be improved based on augmenting scene environments encountered by the model.

In addition, the server directly performs cross-scene conversion on the first image sample feature. Compared with the operation of first performing cross-scene conversion on the first image sample to obtain a corresponding cross-scene image sample and then determining a corresponding second image sample feature based on the cross-scene image sample, an additional calculation amount is reduced, and the training efficiency of the model is ensured.

Furthermore, when performing object type identification by using the initial classifier, the server not only refers to an image sample feature, but also further refers to a texture image. To be specific, the initial classifier comprehensively classifies an image sample from a feature dimension and a texture dimension of an image in a training process, so that the initial identification model learns a more accurate identification capability in a training process, and then the identification model obtained by training can deal with more diverse attack identification means.

When performing object type identification, the identification model obtained by training in some embodiments has a better generalization capability for cross-scene identification and identification of various attack types, and has good identification precision.

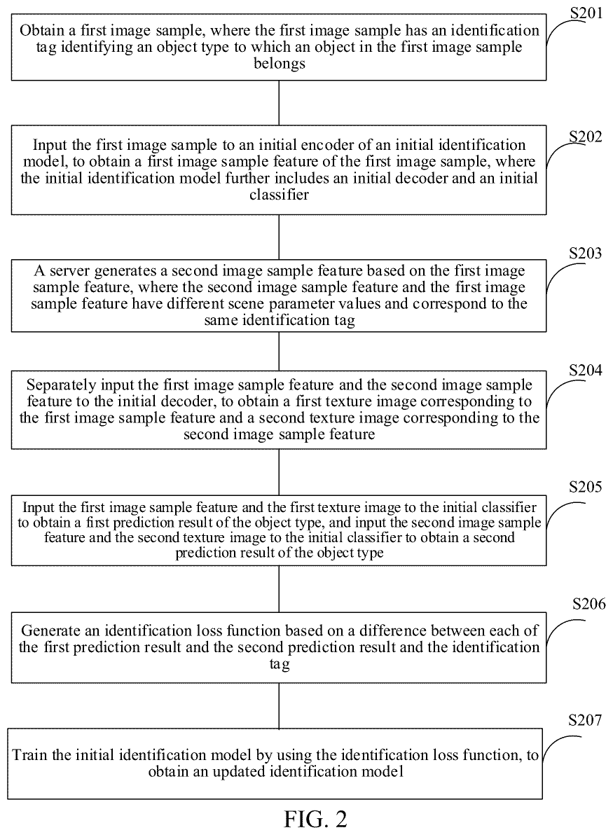

FIG. 2 is a method flowchart of a model determining method according to some embodiments. The method may be performed by a computer device. In some embodiments, an example in which the computer device is a server is used for description. The method includes the following operations.

S201: The server obtains a first image sample, where the first image sample has an identification tag identifying an object type to which an object in the first image sample belongs.

The first image sample is an image that may be used as a training sample of an initial identification model. When a to-be-trained identification model is a living body identification model, the first image sample may be various images including different persons, and in some embodiments, may be an image including different faces, an image including different human palms, or the like. To implement supervised learning training on the initial identification model, the first image sample has a corresponding identification tag. The identification tag can identify an object type to which an object in a corresponding image sample truly belongs. For example, when the identification model is a living body identification model, an identification task of the living body identification model is to identify whether the object in the image sample is a living body. Correspondingly, the identification tag of the first image sample is configured for identifying the object in the first image sample as a living body or a non-living body. In some embodiments, when the identification model is a living body face identification model, an identification task of the living body face identification model is to identify whether a face in an image sample is a living body face. Correspondingly, when the object type of the face in the first image sample is a true living body, content of a corresponding identification tag is a living body face. In some embodiments, when the object type of the face in the first image sample is not a living body, content of a corresponding identification tag is a non-living body face. To be specific, the identification tag can reflect a true object type to which an object in the image sample belongs.

S202: The server inputs the first image sample to an initial encoder of an initial identification model, to obtain a first image sample feature of the first image sample, where the initial identification model further includes an initial decoder and an initial classifier.

The identification model is a model for identifying a type of an object in an image. During actual application, the identification model includes a living body identification model configured to identify whether an object in a currently obtained image is a true living body, and may be a living face identification model configured to identify whether a face in a currently obtained face image is from a true living body, or may be various identification models such as a vehicle identification model configured to identify whether a vehicle in a currently obtained vehicle image is a specific vehicle.

The initial identification model is an initial model of an identification model which may be obtained by training using a first image sample, i.e. an identification model on which model training is not completed. The to-be-trained initial identification model includes an initial encoder, an initial decoder, and an initial classifier. The initial encoder, the initial decoder, and the initial classifier are an encoder, a decoder, and a classifier that need to be trained and optimized. The encoder may obtain, from an image, an image feature reflecting image information in a feature dimension. The decoder may generate, according to the image feature, a texture image reflecting image information in a texture dimension. The classifier may identify an image according to the image information in the feature dimension and the texture dimension.

The image feature refers to a series of quantifiable information reflected in an image. The image feature may be configured for representing content in the image, or content related to an identification task. In some embodiments, the first image sample feature is an image feature corresponding to the first image sample.

In some embodiments, the server determines, by using an initial encoder, a first image sample feature corresponding to a first image sample. The first image sample feature may represent, in a feature dimension, a series of information included in the first image sample. To be specific, the initial encoder may preliminarily analyze the first image sample before identifying the first image sample. The initial encoder is configured to perform feature encoding on the first image sample, to obtain a corresponding first image sample feature. The feature encoding refers to converting an image into feature data that may be processed by a computer, i.e. an image sample feature. The image sample feature may reflect a characteristic of the image. In some embodiments, a convolutional neural network structure may be used as the foregoing initial encoder. Image sample features are extracted layer by layer from inputted image samples by using a plurality of cascaded convolutional layers in the convolutional neural network structure. Finally, an image sample feature outputted by the last convolutional layer is used as the foregoing first image sample feature.

S203: The server generates a second image sample feature based on the first image sample feature, where the second image sample feature and the first image sample feature have different scene parameter values and correspond to the same identification tag.

A scene parameter value of an image sample feature is configured for reflecting content in an image other than a to-be-identified object, and may further be understood as background content in the image other than the object. For example, the scene parameter value may include content such as a background, illumination, and precision of an acquisition device reflected in the image. Correspondingly, the scene parameter may be a background parameter, for example, an image parameter for reflecting background content of a face in the image. Further, the scene parameter may be a parameter reflecting a background type, brightness, contrast, definition, and the like. An image sample may be defined by a scene parameter. In some embodiments, a first image sample corresponding to a first image sample feature and a second image sample corresponding to a second image sample feature are defined by different scene parameters. The two image samples have different scene information, for example, have different content such as a background, illumination, an acquisition environment, and an acquisition device parameter.

When the identification model identifies an image, the identification model is affected by a scene environment in the image. For example, when an image sample is an image acquired in an environment with sufficient light, the identification model obtained through training by using the image sample has a better identification capability for an image with sufficient light during actual application. However, if the image with insufficient light is encountered, even if an object included in the image is the same as an object included in the image sample, the identification model may not accurately identify the image. Therefore, a capability of identifying an object type of an object in different scene environments by the identification model needs to be improved.

In view of this, in some embodiments, a second image sample feature may be generated based on the first image sample feature, where the second image sample feature and the first image sample feature have different scene parameters but correspond to the same identification tag. The second image sample feature corresponds to a second image sample, where the second image sample is a training sample that has a different scene environment and the same identification tag as the first image sample. In some embodiments, the scene environment of the second image sample is different from the scene environment of the first image sample. For example, the first image sample may have an indoor scene and the second image sample may have an outdoor scene. The identification tag of the second image sample and the identification tag of the first image sample are the same, which indicates that objects included in the two image samples are of the same object type and may be the same object. For example, when the identification model is a living body identification model, if the object type of a face in the first image sample is a living body face, the object type of a face in the second image sample may be a living body face, and the faces may be the same face. The second image sample corresponding to the same identification tag as the first image sample is obtained, and the second image sample and the first image sample are both used for training the initial identification model in a subsequent operation, helping the initial identification model to better identify an invariant feature from the same object in a subsequent training process, thereby improving a capability of the identification model to identify the same object in different scene environments.

In some embodiments, the server directly generates the second image sample feature based on the first image sample feature determined in S202 instead of first performing scene conversion on the first image sample to obtain a corresponding second image sample and then determining a corresponding second image sample feature based on the second image sample. The reason for this processing is that encoding the second image sample by using the initial encoder additionally increases a calculation amount in a model training process, thereby affecting model training efficiency. In addition, the first image sample feature can fully reflect information in the image sample, Therefore, more image features in the original first image sample may be reserved for the second image sample feature obtained by using the first image sample feature.

The second image sample feature is generated based on the first image sample feature of the first image sample. Since the second image sample corresponding to the second image sample feature and the first image sample have different scene environments, a scene environment encountered during model training can be augmented, and a capability of identifying the same object in different scene environments by the model can be improved.

In some embodiments, one round of training of the initial identification model may include M (M is an integer greater than 1) first image samples. During actual application, iterative training needs to be performed for the initial identification model. To be specific, a training process of the initial identification model includes a plurality of iteration rounds. In each iteration round, the initial identification model may be trained by using the M first image samples. To be specific, the M first image samples may be inputted into the to-be-trained initial identification model. In this way, one round of training of the initial identification model may include M first image samples.

A j^{th} (j is an integer greater than or equal to 1 and less than or equal to M) first image sample in the M first image samples is used as an example for description. The operation in S203 that the server generates a second image sample feature based on the first image sample feature in some embodiments includes the following operations.

S11: The server determines, for each other first image sample than the j^{th} first image sample in the M first image samples, a feature similarity between the j^{th} first image sample and the other first image samples on the first image sample feature.

The first image sample feature is an image feature corresponding to the first image sample, and the second image sample feature is an image feature that has a different scene parameter but corresponds to the same identification tag as the first image sample feature. Since the first image sample feature and the second image sample feature have different scene parameters, the second image sample feature generated based on the first image sample feature needs to be greatly different from the first image sample feature.

In view of this, for the j^{th} first image sample, the server may first determine a feature similarity between the first image sample features corresponding to the remaining M−1 first image samples in the M first image samples and the first image sample corresponding to the j^{th} first image sample. The feature similarity is configured for representing a similarity degree of different first image samples in an image feature dimension. A higher similarity between first image sample features of different first image samples indicates a larger value of the corresponding feature similarity. The feature similarity may be a cosine similarity. For example, first image sample features of the same batch of image samples are first pooled into a sample feature vector v. Then, the cosine similarity between image samples in the same batch may be determined by using the following formula:

$$S = Softmax ( \frac{v}{{‖ v ‖}_{2}} \cdot \frac{{v}^{T}}{{‖ v ‖}_{2}} )$$

where S represents the cosine similarity between image samples in the same batch, Softmax represents a normalization function, v represents the sample feature vector v determined by pooling the first image sample features of the same batch of image samples, v^{T} represents a transposed matrix of v, and ∥v∥₂ represents a two-norm of v.

S12: The server determines other first image samples having corresponding feature similarities less than a similarity threshold as difference samples.

The server may determine a first image sample having the feature similarity lower than a similarity threshold in the M−1 first image samples as a difference sample. The difference sample is the first image sample greatly different from the j^{th} first image sample. Since the second image sample feature generated based on the first image sample feature needs to be greatly different from the first image sample feature, the foregoing difference sample may be used as a basis for generating the second image sample feature. For example, when the feature similarity is a cosine similarity, the difference sample may be determined by using the following formula:

$${H}_{j , k} = 1 [ {S}_{j , k} < median ( {S}_{j , :} ) ]$$

where H_{j,k} represents the first image sample feature corresponding to a k^{th} first image sample (the k^{th} first image sample is the difference sample of the j^{th} first image sample) in the M first image samples, 1[⋅] represents an indicator function, S_{j,k} represents the cosine similarity between the j^{th} first image sample and the k^{th} first image sample, S_{j,:} represents the cosine similarity between the j^{th} first image sample and all the M−1 first image samples, and median(α) represents calculating a median for α.

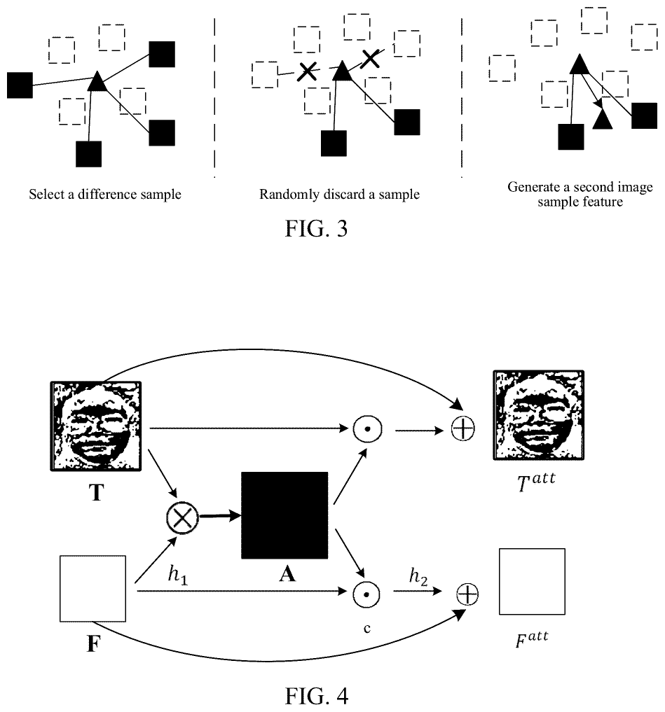

By using the formula, the similarity threshold may be determined as a median of the cosine similarity between the j^{th} first image sample and the remaining M−1 first image samples, and an image sample having the cosine similarity lower than the median in the M−1 first image samples as the difference sample. As shown in FIG. 3, the first image sample greatly different from the j^{th} first image sample is determined as the difference sample.

S13: The server generates a second image sample feature of the j^{th} first image sample according to the first image sample feature of the difference sample and the first image sample feature of the j^{th} first image sample.

After the difference sample is determined, the second image sample feature and the first image sample feature have different scene parameters, but have the same identification tag. Therefore, although the second image sample feature and the first image sample feature need to be greatly different with respect to the features of the scene environment, a high similarity between the second image sample feature and the first image sample feature with respect to the features of the identification tag is required. In view of this, the server cannot directly generate the second image sample feature according to the first image sample feature of the difference sample, but generates the second image sample feature for the j^{th} first image sample according to the respective first image sample features of the difference sample and the j^{th} first image sample.

Furthermore, to further improve diversity of the second image sample feature, after the difference samples are determined, a particular quantity of difference samples may be randomly discarded first. For example, as shown in FIG. 3, half of the difference samples may be randomly discarded, and then the second image sample feature for the j^{th} first image sample is generated according to the remaining difference samples and the j^{th} first image sample.

The server first determines a difference sample greatly different from a first image sample, and then generates a second image sample feature for the first image sample according to first image sample features corresponding to the difference sample and the first image sample. To be specific, the second image sample feature having a scene parameter different from that of the first image sample feature is obtained, thereby implementing extension of an image sample in a scene environment.

In the process of generating a second image sample feature, it needs to be ensured that the second image sample corresponding to the second image sample feature and the first image sample have the same identification tag. Therefore, in some embodiments, the operation in S13 that the server generates a second image sample feature of the j^{th} first image sample according to the first image sample feature of the difference sample and the first image sample feature of the j^{th} first image sample may include the following operations.

S21: The server generates an initial second image sample feature according to the first image sample feature of the difference sample and the first image sample feature of the j^{th} first image sample.

The server may first generate, according to the respective first image sample features of the difference sample and the j^{th} first image sample (for example, the first image sample feature of the difference sample and the first image sample feature corresponding to the j^{th} first image sample are mixed or combined or spliced), an initial second image sample feature for the j^{th} first image sample. The initial second image sample feature is an image feature having different feature information from the first image sample feature of the j^{th} first image sample. The initial second image sample feature carries the feature information of the first image sample feature of the difference sample, and since the initial second image sample feature is not equivalent to the second image sample feature and is essentially an intermediate feature in the process of generating the second image sample feature, it is not necessary to ensure that the initial second image sample feature and the first image sample feature represent the same object. For example, the initial second image sample feature for the j^{th} first image sample may be obtained according to the following formula:

$${V}^{′} = \frac{{S}^{′}}{{‖ {S}^{′} ‖}_{1}} \times V$$

$$where {S}^{′} = Dropout ( H ⋆ S )$$

where H represents the first image sample feature of the difference sample of the j^{th} first image sample, S represents the cosine similarity between the first image samples in the same batch, α*β represents an element-by-element product of α and β, Dropout represents a discarding function, S′ represents the first image sample feature of the remaining discarded difference samples, ∥S′∥₁ represents a one-norm of S′, V represents the first image sample feature of the j^{th} first image sample, and V′ represents an initial second image sample feature of the j^{th} first image sample.

In the formula, to further improve diversity of the second image sample feature, not all the difference samples are directly used, but the remaining difference samples randomly discarded are used. Then one-norm regularization is used on the first image sample features of the remaining difference samples, to ensure that a sum of all rows is 1. The initial second image sample feature of the j^{th} first image sample is determined in conjunction with the first image sample feature of the j^{th} first image sample.

S22: The server uses the first image sample feature of the j^{th} first image sample as a mixing constraint, and mixes the first image sample feature of the j^{th} first image sample and the initial second image sample feature, to obtain the second image sample feature of the j^{th} first image sample.

The second image sample feature needs to be generated with reference to the first image sample feature of the difference sample. Due to the impact of the first image sample feature of the difference sample, the generated second image sample feature and the first image sample feature of the j^{th} first image sample may correspond to different identification tags. In a case that the two features correspond to different identification tags, subsequent operations cannot be performed normally. To be specific, the identification tag of the j^{th} first image sample and the second prediction result determined based on the second image sample feature cannot be used for constructing a loss function, and the initial identification model is trained accordingly. To avoid the foregoing situation, operation S22 needs to be used for constraining the generated second image sample feature based on the first image sample feature of the j^{th} first image sample in the process of generating the second image sample feature, to ensure that the generated second image sample feature and the first image sample feature correspond to the same identification tag.

In some embodiments, after the initial second image sample feature having feature information significantly different from that of the first image sample feature is generated, to ensure that the first image sample feature and the second image sample feature represent the same object, the server may use the first image sample feature of the j^{th} first image sample as a mixing constraint in the process of mixing the first image sample feature of the j^{th} first image sample and the initial second image sample feature, which indicates that the first image sample feature of the j^{th} first image sample and the initial second image sample feature are not randomly mixed. However, by using the original first image sample feature of the j^{th} first image sample as a constraint, it is ensured that the obtained second image sample feature and the first image sample feature represent the same object. To be specific, it is ensured that the first image sample corresponding to the first image sample feature and the second image sample corresponding to the second image sample feature have the same identification tag. For example, when the identification model identifies a living body, the first image sample feature is used as a mixing constraint to ensure that the second image sample corresponding to the obtained second image sample feature and the first image sample represent the same face, thereby avoiding that the obtained second image sample feature is incorrect when the identification tag of the first image sample feature is used as a corresponding true value in subsequent operations, ensuring that the initial identification model may be directly trained and optimized according to the second image sample feature and the identification tag in subsequent operations, and helping the model to better identify an invariant feature from the same object in a subsequent training process. As shown in FIG. 3, the feature information of the first image sample feature and the initial second image sample feature may be mixed by using an exact feature distribution mixing (EFDMix) technology, so as to ensure that the feature information of the first image sample feature about the identification tag remains unchanged to obtain the corresponding second image sample feature. Also, the first image sample feature and the initial second image sample feature may be mixed by using an adaptive instance normalization (AdaIN) algorithm.

An initial second image sample feature having different feature information from that of a first image sample feature of a j^{th} first image sample is first directly generated. Then, in a process of mixing the first image sample feature and the initial second image sample feature, an original first image sample feature is used as a mixing constraint, so that the obtained second image sample feature and the first image sample feature represent the same object. To be specific, a second image sample corresponding to the second image sample feature and the first image sample have the same identification tag, thereby avoiding that the obtained second image sample feature is incorrect when the identification tag of the first image sample feature is used as a corresponding true value in subsequent operations, and ensuring that the initial identification model may be directly trained and optimized according to the second image sample feature and the identification tag in the subsequent operations.

S204: The server inputs the first image sample feature and the second image sample feature to the initial decoder, to obtain a first texture image corresponding to the first image sample feature and a second texture image corresponding to the second image sample feature.

A texture image is an image that can reflect texture of an image. For example, the texture image includes local binary pattern (LBP) images, as well as other LBP variant images such as color LBP images, and LBP in an HSV color space or a YCbCr color space. Texture is an image feature that can reflect distribution attributes of pixels in an image, and may be expressed by a gray distribution of the pixels and surrounding spatial neighborhoods thereof. The texture of the image is usually locally irregular and macroscopically regular. The image can be more abundantly expressed in the texture dimension by obtaining the texture image of the image. In some embodiments, the first texture image is a texture image corresponding to the first image sample feature, and the second texture image is a texture image corresponding to the second image sample feature.

In some embodiments, the initial decoder may obtain a first texture image corresponding to an image sample according to a first image sample feature. The first image sample feature refers to a series of information reflected by the image sample in a feature dimension, and the first texture image refers to visual information reflected by the image sample in a texture dimension. To be specific, in some embodiments, in addition to performing analysis processing on the image sample in the feature dimension, analysis processing is further performed in the texture dimension. To be specific, before identifying the object type of the object in the image sample, the initial identification model performs analysis processing on the image sample in both the feature dimension and the texture dimension.

Furthermore, in some embodiments, the initial decoder may further obtain a corresponding second texture image according to a second image sample feature. The second image sample feature refers to a series of information reflected by a second image sample in a feature dimension, and the second texture image refers to visual information reflected by the second image sample in a texture dimension. To be specific, in some embodiments, in addition to obtaining information of the second image sample in the feature dimension, information of the second image sample in the texture dimension is further obtained, so that corresponding information is obtained in two dimensions, i.e. feature and texture, before the second image sample is identified.

In some embodiments, the initial decoder is configured to perform feature decoding according to the image sample feature. The feature decoding is a reverse process of feature encoding, and is configured for restoring an image sample feature in a data form to a texture image in an image form.

S205: The server inputs the first image sample feature and the first texture image to the initial classifier to obtain a first prediction result of the object type, and inputs the second image sample feature and the second texture image to the initial classifier to obtain a second prediction result of the object type.

An object type prediction result is a prediction result of an object type of an object in an image that is obtained after the image is identified by using a model. The prediction result may be a probability value. For example, when the identification model is a living body identification model, the object type prediction result obtained after a face image is identified by using the living body identification model may be that a probability of a living body is 0.7. In some embodiments, the first prediction result is the object type identification result corresponding to the first image sample, and the second prediction result is the object type identification result corresponding to the second image sample.

In a training process of an identification model in the related art, a prediction result of a corresponding object type is usually determined only according to an image sample feature of an image sample. Consequently, a capability of identifying information in an image by the identification model obtained by training is insufficient. Consequently, when the identification model obtained by training in the related art faces cross-attack type identification, it is difficult to reach a needed generalization requirement.

During actual application, the identification model may encounter various attack types, or even encounter a new attack type that is not trained in a training process. Therefore, to learn a more accurate identification capability in the training process of the initial identification model, in some embodiments, the server determines the first prediction result of the object type through the initial classifier according to the first image sample feature and information in two dimensions of the first texture image. To be specific, in some embodiments, the initial classifier obtains a corresponding first prediction result instead of obtaining a prediction result corresponding to the first image sample only according to the first image sample feature, but obtains a corresponding first prediction result by comprehensively considering the first image sample feature and the first texture image. To be specific, the model comprehensively classifies an image sample from a feature dimension and a texture dimension in a training process, so that the initial identification model more precisely and comprehensively refers to information in the image sample in the training process, and classifies the image sample accordingly.

Furthermore, in some embodiments, the initial classifier further determines the second prediction result of the object type corresponding to the second image sample according to the second image sample feature and information in two dimensions of the second texture image. To be specific, the initial classifier further comprehensively considers the second image sample feature and the second texture image to obtain the second prediction result of the corresponding object type. To be specific, the model further comprehensively classifies a cross-scene image sample from the feature dimension and the texture dimension in the training process, so that the initial identification model more precisely and comprehensively refers to the information in the second image sample in the training process, and classifies the cross-scene image sample accordingly.

Based on the initial identification model including the initial encoder, the initial decoder, and the initial classifier, in some embodiments, the initial identification model further includes an initial feature embedding module. The operation in S204 that the server inputs the first image sample feature and the first texture image to the initial classifier, to obtain a first prediction result of the object type may include the following operations.

The server inputs the first image sample feature to the initial feature embedding module, to obtain a corresponding first embedded feature.

The server inputs the first embedded feature and the first texture image to the initial classifier, to obtain the first prediction result.

The initial feature embedding module is a feature embedding module that needs to be trained and optimized. The feature embedding module may secondarily extract the image feature, to obtain a more precise embedded feature. The embedded feature is a feature that can more accurately reflect image content information.

To further improve quality of data that is inputted to and processed by the initial classifier, the server may determine the corresponding first embedded feature according to the first image sample feature by using the initial feature embedding module. To be specific, the image sample feature is secondarily processed by using the initial feature embedding module, to obtain the embedded feature that can more accurately reflect the image content information.

Based on the first embedded feature obtained by using the initial feature embedding module, the first embedded feature and the first texture image may be inputted to the initial classifier, so that the initial classifier performs classification and identification accordingly. In some embodiments, the first embedded feature that is more accurate than the first image sample feature is inputted to the initial classifier, helping the initial classifier to obtain a more accurate type identification result.

Furthermore, in some embodiments, by using the initial feature embedding module, a corresponding second embedded feature may further be obtained according to the second image sample feature, and the second embedded feature and the second texture image may be jointly inputted to the initial classifier, to determine the second prediction result of the object type.

Based on obtaining the image sample feature, the server secondarily analyzes the image sample feature by using the initial feature embedding module, to obtain an embedded feature that can more accurately reflect the image content information, thereby improving quality of data inputted to the initial classifier, and helping the initial classifier to obtain a more accurate type identification result.

S206: The server generates an identification loss function based on a difference between each of the first prediction result and the second prediction result and the identification tag.

The first prediction result is a prediction result of an object type of an object in the first image sample obtained after the first image sample is identified by using the initial identification model. The second prediction result is a prediction result of an object type obtained after the second image sample feature and the second texture image are identified by using the initial classifier in the initial identification model. The identification tag is a tag identifying a true object type of the object in the first image sample. The server can obtain, based on the foregoing difference between the prediction result obtained by using the initial identification model and the identification tag, the identification loss function that may reflect a training optimization direction of the initial identification model. For example, for the initial identification model, the identification loss function may be obtained by using the following formula:

$${L}_{C E} = - [ y log ( {y}^{′} ) + ( 1 - y ) log ( 1 - {y}^{′} ) ]$$

where L_{CE} refers to the identification loss function, y refers to the identification tag, and y′ refers to the first prediction result or the second prediction result. The identification loss function of the initial identification model may be obtained by using the foregoing formula. For example, when the identification model identifies a living body, the object in the image sample is a true living body, and a value of the corresponding identification tag is 1. If a probability value of the first prediction result of the image sample is 0.8, the corresponding identification loss function may be calculated according to the identification tag and the first prediction result by using the foregoing formula.

Since the second image sample feature is generated based on the first image sample feature, in the process of generating an identification loss function based on a difference between each of the first prediction result and the second prediction result and the identification tag, the server may apply a particular weight to a loss corresponding to the second prediction result. For example, a weight of 0.1 is applied to the loss corresponding to the second prediction result, so that the identification loss function still uses an actually obtained image sample as a main training sample.

S207: The server trains the initial identification model by using the identification loss function, to obtain an updated identification model.

After the identification loss function is obtained in S205, since the identification loss function may reflect the training optimization direction of the initial identification model, the server may train the initial identification model according to the identification loss function, to obtain an applicable identification model.

Since the identification loss function is obtained comprehensively according to the first prediction result and the second prediction result and the first prediction result and the second prediction result correspond to the first image sample and the second image sample, the identification model obtained through training by using the identification loss function can achieve a better generalization capability in the face of cross-scene identification. In addition, since the foregoing prediction result is obtained by comprehensively identifying the feature dimension and the texture dimension, the identification model obtained through training by using the identification loss function has a more accurate and more comprehensive identification capability, and can deal with diverse identification attack means. In conclusion, the identification model has a better generalization capability for cross-scene identification and identification of various attack types.

In the process of identifying image sample features and texture images in different dimensions by using an initial classifier to obtain a prediction result of an object type, if information-level interaction can be better performed on the image sample features and the texture images, a more accurate type identification result can be obtained. In some embodiments, the operation in S204 that the server inputs the first image sample feature and the first texture image to the initial classifier, to obtain a first prediction result of the object type may include the following operations.

S31: The server maps the first image sample feature to a feature space of the first texture image, to obtain a mapped sample feature.

The first image sample feature is a series of information reflected in the feature dimension by the first image sample, the first texture image is visual information in an image reflected in the texture dimension by the first image sample, and the first image sample feature and the first texture image are not in the same feature space. Therefore, to perform information-level interaction on the first image sample feature and the first texture image in the same feature space, the server may map the first image sample feature to the feature space of the first texture image, to obtain a mapped sample feature in the feature space of the first texture image. The mapped sample feature and the first image sample feature have the same image information and can reflect content of the image sample in the feature dimension, as shown in FIG. 4. In FIG. 4, F represents the first image sample feature, and T represents the first texture image. F is projected to a space having the same channel dimensionality as T by using a 1×1 convolutional neural network h₁. To be specific, F is projected to the feature space of T, to obtain a mapped sample feature F′.

S32: The server determines a sample attention map based on feature distributions of the mapped sample feature and the first texture image for the same image region, where the sample attention map is configured for identifying an attention weight corresponding to an image region in the first image sample in an object type identification task.

The mapped sample feature and the first texture image that are located in the same feature space both have corresponding feature distributions for the image region of the first image sample. Since the mapped sample feature and the first texture image reflect content of the image region from different dimensions, feature scores of the mapped sample feature and the first texture image for the same image region are usually different. For example, when the feature distribution of the mapped sample feature for an image region has more feature information, the feature distribution of the first texture image for the image region may have more feature information, or may have less feature information.

In view of this, the server may determine, based on the feature distributions of the mapped sample feature and the first texture image for the same image region, the sample attention map capable of comprehensively reflecting the feature distribution of the first image sample. The sample attention map is configured for identifying an attention weight corresponding to the image region in the first image sample in an object type identification task. In some embodiments, an attention weight of the image region for the identification object type in the image sample under the guidance of the feature distributions of the mapped sample feature and the first texture image is identified. The attention weight helps the initial classifier to subsequently comprehensively perform better classification and identification according to the mapped sample feature and the first texture image. For example, when the feature distribution of the mapped sample feature for an image region has more feature information and the feature distribution of the first texture image for the image region also has more feature information, an attention weight of the image region reflected by the sample attention map is relatively high. As the attention weight of the image region is higher, more attention is allocated to the image region when the object type is identified by the initial classifier in subsequent operations, so that a corresponding type identification result is more accurate. To be specific, the mapped sample feature and the first texture image are interacted at an information level, to obtain an attention map that can guide identification of the initial classifier. As shown in FIG. 4, a sample attention map A may be obtained by performing matrix multiplication on a mapped sample feature F′ and the first texture image T.

S33: The server generates an attention sample feature according to the mapped sample feature and the sample attention map, and generates an attention texture image according to the first texture image and the sample attention map.

After obtaining the sample attention map, the server may generate an attention sample feature corresponding to the mapped sample feature and an attention texture image corresponding to the first texture image by using the sample attention map. The attention sample feature is supplemented with feature information of the first texture image based on the mapped sample feature by using the sample attention map. The attention sample feature carries the feature information of the first texture image. The attention texture image is supplemented with feature information of the mapped sample feature based on the first texture image by using the sample attention map. The attention texture image carries the feature information of the mapped sample feature. Therefore, the mapped sample feature and the first texture feature complete feature complementation. As shown in FIG. 4, the attention map A may be applied to the mapped sample feature F′ and the first texture image T, and an attention texture image T^{att} and an attention sample feature F^{att} may be obtained through another 1×1 convolutional neural network h₂.

S34: The server inputs the attention sample feature and the attention texture image to the initial classifier, and determines the first prediction result.

After obtaining the attention sample feature and the attention texture image, the initial classifier may comprehensively obtain the corresponding first prediction result according to the attention sample feature and the attention texture image. In some embodiments, the attention texture image T^{att} and the attention sample feature F^{att} may be combined by a cascade operation as an input to the initial classifier. Since the attention sample feature not only carries information of the first image sample feature, but also carries information of the first texture image, and the attention texture image not only carries information of the first texture image, but also carries information of the first image sample feature, the initial classifier can more comprehensively classify the image sample accordingly, to obtain a more reliable first prediction result.

In some embodiments, the server may map the second image sample feature to a feature space of the second texture image, to obtain a cross-scene mapped sample feature. Then, a cross-scene sample attention map is determined based on the cross-scene mapped sample feature and a feature distribution of the same image region in the second texture image. Then, a cross-scene attention sample feature is generated according to the cross-scene mapped sample feature and the cross-scene sample attention map, and a cross-scene attention texture image is generated according to the second texture image and the cross-scene sample attention map. Finally, the cross-scene attention sample feature and the cross-scene attention texture image are inputted to the initial classifier, to determine a second prediction result.

For an image sample, an attention mechanism combining a feature dimension and a texture dimension enables the first image sample feature and the first texture image to interact at an information level, to obtain an attention texture image carrying information of the first image sample feature and an attention sample feature carrying information of the first texture image. The attention texture image and the attention sample feature are used as inputs of the initial classifier, so that quality of data inputted to the initial classifier can be effectively improved, thereby improving accuracy of a corresponding class identification result.

When information in different dimensions is mixed according to an attention mechanism, to obtain, from the perspective of finer granularity, a sample attention map capable of reflecting more detailed information, in some embodiments, the method further includes the following operations.

S41: The server divides the first image sample into N sub-image regions, where N is an integer greater than 1.

The operation S31 in which the server maps the first image sample feature to a feature space of the first texture image, to obtain a mapped sample feature may include the following operations.

S42: The server determines, according to the first image sample feature, N sub-features corresponding to the N sub-image regions, and maps the N sub-features to the feature space of the first texture image, to obtain N sub-mapped features forming the mapped sample feature.

For an i^{th} sub-image region in the N sub-image regions (i is an integer greater than or equal to 1 and less than or equal to N), the operation in S32 that the server determines a sample attention map based on the mapped sample feature and a feature distribution of the same image region in the first texture image may include the following operations.

S43: The server obtains an i^{th} sub-mapped feature corresponding to the i^{th} sub-image region in the mapped sample features, and an i^{th} texture grid corresponding to the i^{th} sub-image region in the first texture image.

S44: The server determines, according to feature distributions of the i^{th} sub-mapped feature and the i^{th} texture grid, a sub-attention map corresponding to the i^{th} sub-image region in the sample attention map.

Feature information included in different image regions of the first image sample is not uniform, the first image sample feature reflects an image feature of an entire image region of the first image sample, and the first texture image reflects a texture image of an entire image region of the first image sample. If the sample attention map corresponding to the entire image region of the first image sample is directly determined based on the first image sample and the first texture image that correspond to the entire image region, the obtained sample attention map may lose detailed information of some image samples.

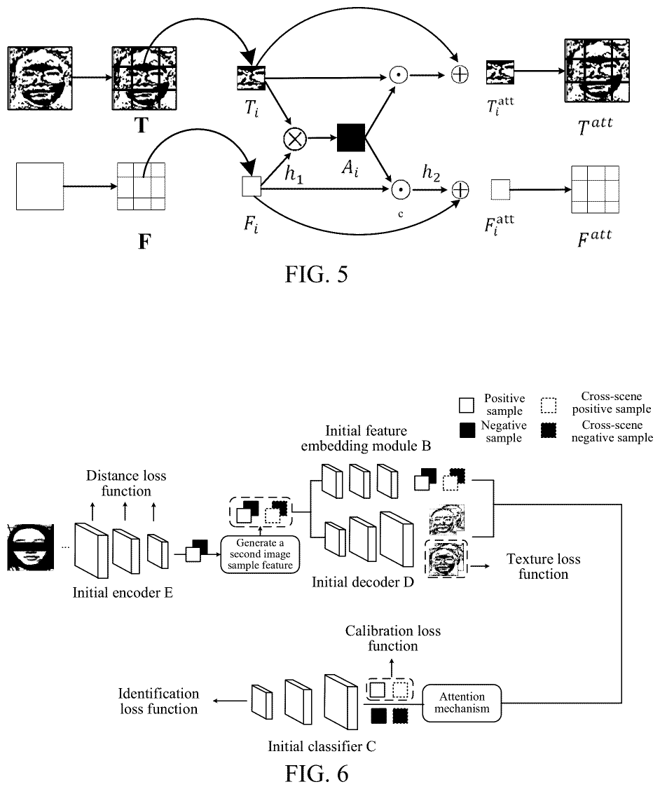

In view of this, the server may first divide the first image sample into a plurality of sub-image regions. To be specific, the first image sample is first divided. A finer image region is divided, a larger quantity of obtained sub-image regions is obtained, and more detailed information of the image sample can be better noticed by the identification model in subsequent operations. However, a calculation amount of the model also correspondingly increases. Therefore, the quantity of sub-image regions may be set by a person skilled in the art according to requirements. Meanwhile, in the division process, the image region may be evenly divided, or the image region may be unevenly divided. This is not limited herein. When the image region is evenly divided, the image region may be divided into P×P grids, where a value of P is automatically set according to a requirement. For example, P may be 2, 4, or 8. As shown in FIG. 5, the value of P may be 3, and the image region is divided into 3×3 grids.

After the first image sample is divided to obtain a plurality of sub-image regions, the server may map the first image sample feature to the feature space of the first texture image according to the plurality of sub-image regions. In some embodiments, sub-features corresponding to the plurality of sub-image regions are first determined in the first image sample feature, where the sub-features are image features corresponding to the sub-image regions. To be specific, the first image sample feature is first divided according to the sub-image regions, to obtain sub-features corresponding to the sub-image regions, and then the sub-features corresponding to the plurality of sub-image regions are mapped to the feature space of the first texture image, to obtain sub-mapped features corresponding to the plurality of sub-image regions, where the sub-mapped features are mapped image features corresponding to the sub-image regions, thereby laying a foundation for subsequently processing the first texture image and the mapped sample feature according to the plurality of sub-image regions in the feature space of the first texture image. As shown in FIG. 5, according to a 3×3 grid, the first image sample feature F may be divided to obtain a plurality of sub-features, where an i^{th} sub-feature corresponding to an i^{th} sub-image region may be represented by Fᵢ. Then, Fᵢ may be projected to a space having the same channel dimensionality as the first texture image T by using a 1×1 convolutional neural network h₁. To be specific, Fᵢ is projected to the feature space of T, to obtain an i^{th} sub-mapped feature F′ corresponding to the i^{th} sub-image region.

After obtaining the sub-mapped features corresponding to the plurality of sub-image regions, the server may determine a sample attention map according to the plurality of sub-image regions. Taking the i^{th} sub-image region in the plurality of sub-image regions as a schematic for specific description, an i^{th} sub-mapped feature corresponding to the i^{th} sub-image region and an i^{th} texture grid corresponding to the i^{th} sub-image region in the first texture image may be first obtained, where the i^{th} sub-mapped feature is a mapped image feature corresponding to the i^{th} sub-image region, and the i^{th} texture grid is a texture image corresponding to the i^{th} sub-image region. Then, based on the feature distributions of the i^{th} sub-mapped feature and the i^{th} texture grid, an i^{th} sub-attention map capable of reflecting the feature distribution of the i^{th} sub-image region from two dimensions is determined. As shown in FIG. 5, an i^{th} sub-attention map Aᵢ may be obtained by performing matrix multiplication on an i^{th} sub-mapped feature F′ᵢ and an i^{th} texture grid Tᵢ.

To be specific, after the sub-image regions are divided, the server may determine a corresponding sub-attention map according to the divided sub-image regions. The sub-attention map is an attention map corresponding to the sub-image region, and is an attention weight of the sub-image region for the identification object type under the guidance of the feature distributions of the sub-mapped feature and the sub-texture grid corresponding to the sub-image region. To be specific, in some embodiments, instead of directly obtaining an attention weight of an entire image region of the first image sample, an attention weight of each sub-image region is obtained by means of division, and the first image sample feature and the first texture image interact with each other at an information level in more details according to the sub-image region, so that the initial classifier can subsequently notice which sub-image region features in the first image sample are more relevant to the object type identification. To be specific, the initial classifier can better notice detailed information related to the object type identification in the first image sample, thereby improving identification precision.

Furthermore, after obtaining the sub-attention map, the server may first generate, by using the sub-attention map, a sub-attention sample feature corresponding to the sub-mapped feature and a sub-attention texture grid corresponding to the sub-texture grid. As shown in FIG. 5, the i^{th} sub-attention map Aᵢ is applied to the i^{th} mapped feature F′ᵢ and the i^{th} texture grid Tᵢ by element-by-element multiplication, and an i^{th} sub-attention sample feature Fᵢ^{att} and an i^{th} sub-attention texture grid Tᵢ^{att} may be obtained by residual connection. For example, Fᵢ^{att} and Tᵢ^{att} may be obtained by using the following formula:

$${T}_{i}^{a t t} = A v g ( {A}_{i} ) ⊗ {T}_{i} + {T}_{i}$$

$${F}_{i}^{a t t} = {h}_{2} ( A v g ( {A}_{i} ) ⊗ {F}_{i}^{′} ) + {F}_{i}$$

where Tᵢ^{att} represents the i^{th} sub-attention texture grid, Avg(α) represents averaging α in a dimension, Aᵢ represents the sub-attention map, ⊗ represents a Kronecker product, Tᵢ represents the i^{th} texture grid, Fᵢ^{att} represents the i^{th} sub-attention sample feature, h₂ represents a 1×1 convolutional neural network, configured to project an input to a space having the same channel dimensionality as Tᵢ, F′ᵢ represents the i^{th} sub-mapped feature, and Fᵢ represents the i^{th} sub-feature.

Then, the sub-attention sample features are reassembled to obtain an attention sample feature, and the sub-attention texture images are reassembled to obtain an attention texture image. As shown in FIG. 5, the sub-attention sample feature Fᵢ^{att} and the sub-attention texture grid Tᵢ^{att} are reassembled to obtain a corresponding attention sample feature F^{att} and attention texture image T^{att}, and T^{att} and F^{att} are combined by a cascade operation as an input o the initial classifier.

In some embodiments, the server may first divide the second image sample into a plurality of sub-image regions based on the image region of the first image sample. Then, the second image sample feature is mapped to a feature space of the second texture image according to the plurality of sub-image regions, to obtain a plurality of sub-cross-scene mapped features. Next, corresponding sub-cross-scene attention maps are determined for the plurality of sub-image regions according to the plurality of sub-cross-scene mapped features and texture grids respectively corresponding to the plurality of sub-image regions.

For an image sample, sub-image regions are divided first, and then an attention weight is determined, so that the first image sample feature and the first texture image interact with each other at an information level in more details according to the sub-image region. From the perspective of finer granularity, the initial classifier can notice which sub-image region features in the image sample are more relevant to the object type identification. To be specific, the initial classifier can better notice detailed information related to the object type identification in the image sample, thereby improving model identification precision.

It can be seen that this application provides a method for training an identification model for identifying an object type of an object in an image. A to-be-trained initial identification model includes an initial encoder, an initial decoder, and an initial classifier. In some embodiments, when the initial identification model is trained, a first image sample feature of a first image sample is first determined by using the initial encoder in the initial identification model. The first image sample has an identification tag identifying an object type to which an object belongs. To improve an identification capability of the model for objects in different scene environments, in this application, a second image sample feature is generated based on the first image sample feature, where the second image sample feature and the first image sample feature have different scene parameters but correspond to the same identification tag. For the two image sample features, corresponding texture images may be obtained by using the initial decoder, corresponding object type prediction results may be determined by using the initial classifier according to the image sample features and the corresponding texture images, and then an initial identification model is trained by using an identification loss function generated based on the identification tag and the prediction results, to obtain an updated identification model. Cross-scene conversion is performed on the first image sample feature, to obtain the second image sample feature that has a different scene parameter and the same identification tag as the first image sample feature, so that the initial identification model may learn a capability of identifying the same object in different scene environments during training. In addition, the cross-scene conversion is directly performed on the first image sample feature, thereby avoiding encoding processing on an additional sample, and avoiding a substantial impact on model training efficiency. When an object type is predicted, in addition to the image sample features, a texture image is further introduced, and image information is more abundantly expressed from a feature dimension and a texture dimension, so that the initial identification model learns a more accurate identification capability in a training process, and can deal with more diverse attack identification means. When the identification model obtained by training performs object identification, the identification model has a good generalization capability for images having different scenes and images generated in different modes, thereby effectively improving model identification accuracy.

In this application, the prediction result of the initial identification model is measured by using the identification loss function. To be specific, a difference between a model prediction value (the prediction result) and an actual value (the identification tag) of the initial identification model is evaluated by using the identification loss function, and the initial identification model is trained by using the identification loss function, to obtain an identification model with particular identification precision.

In view of this, to further improve identification accuracy of the identification model, another type of loss function may further be introduced to train the initial identification model together with the identification loss function. In some embodiments, the first image sample includes a positive sample and a negative sample, an identification tag of the positive sample identifies that an object in the positive sample belongs to a true object type, and an identification tag of the negative sample identifies that an object in the negative sample belongs to a false object type. Based on the texture image generated in S203, the method further includes the following operations.

The server generates a texture loss function based on a difference between a first texture image corresponding to the positive sample and a texture tag of the positive sample. The first texture image corresponding to the positive sample is obtained by inputting the first image sample feature of the positive sample to the initial decoder.

The operation in S206 that the server trains the initial identification model by using the identification loss function to obtain an identification model may include the following operations.

The server trains the initial identification model by using the identification loss function and the texture loss function, to obtain the updated identification model.

The first image sample is an image that may be used as a model training sample. For an initial identification model, the positive sample is an image sample in which an object included in the sample is a true object type, and the negative sample is an image sample in which an object included in the sample is a false object type. For example, when the trained identification model is configured to identify a living body, the object included in the positive sample is a true living body, and the object included in the negative sample may be a false face not belonging to a true living body, such as a video face screenshot or a face photo. If the initial identification model is trained by using only the positive sample, a false detection probability and a false identification rate of the obtained identification model are relatively high. Therefore, to reduce the false detection probability and the false identification rate of the model, the first image sample not only includes the positive sample, but also includes the negative sample.

When the initial identification model is trained, corresponding identification loss functions are obtained for both the positive sample and the negative sample by using the initial encoder, the initial classifier, and the initial identifier in the initial identification model, to obtain an identification model having an identification capability. To be specific, in S203, corresponding texture images may be obtained for both the positive sample and the negative sample through the initial decoder. In some embodiments, to enable the identification model to better distinguish a true object type from a false object type, the server measures only generation precision of the first texture image corresponding to the positive sample. To avoid that information of the negative sample interferes generation of the texture loss function related to only the positive sample, a single image sample may be processed by using instance normalization (IN) instead of using batch normalization (BN) commonly used in a convolutional neural network to process the same batch of image samples. In some embodiments, the server may generate a texture loss function based on a difference between the first texture image of the positive sample and a texture tag of the positive sample. The texture tag is a texture image expected to be generated for the positive sample, i.e. a texture image that is expected by the server, can be generated by the initial identification model, and may fully reflect information of the positive sample in the texture dimension, for example, a batch of image samples X∈ [symbol] ^{n×h×w×3} for the living body identification model, where n is the number of image samples in a batch, and h, w are the height and width of the image sample. The positive sample of the living body identification model is a sample in which the included object is a true living body, and the negative sample is a sample in which the included object is a false non-living body. The texture loss function of the living body identification model may be obtained by the following formula:

$${L}_{A E} = {‖ D ( E ( {X}^{live} ) ) - {M}^{live} ‖}_{1}$$

where L_{AE} represents the texture loss function, X^{live} represents a positive sample in a batch of image samples, E represents processing corresponding to the initial encoder, D represents processing corresponding to the initial decoder, D(E(X^{live})) represents the first texture image corresponding to the positive sample, M^{live} represents a texture tag of the positive sample, and ∥α∥₁ represents a one-norm of α.

By using the formula, a difference between the texture tag of the positive sample and the first texture image obtained by the initial encoder and the initial decoder by processing the positive sample is evaluated. To be specific, generation precision of the first texture image of the positive sample is measured.

Although a corresponding second texture image is further generated for the second image sample corresponding to the positive sample in this application, to ensure the training efficiency of the model, the server directly generates the second image sample feature by using the first image sample feature, rather than first performing cross-scene conversion on the first image sample to obtain the corresponding second image sample, and then determining the corresponding second image sample feature by using the second image sample. If the generation precision of the second texture image is also measured, the second image sample needs to be first generated according to the second image sample feature, and then the corresponding cross-scene texture tag is generated according to the second image sample, so that the generation precision of the second texture image can be evaluated based on the cross-scene texture tag. This undoubtedly increases the calculation amount of the model. Moreover, in this application, parameters used by the initial decoder to generate the first texture image and the second texture image are the same. Therefore, based on that the generation precision of the first texture image has been evaluated, the generation precision of the second texture image does not need to be evaluated.

After obtaining the texture loss function, the server may train the initial identification model by using the identification loss function and the texture loss function together. Since the texture loss function is obtained by using a difference between the first texture image of the positive sample and the texture tag of the positive sample, only the positive sample is involved, but the negative sample is not involved. To be specific, the texture loss function is asymmetric. Training the initial identification model by using the asymmetric texture loss function enables the identification model obtained by training to better distinguish between texture images of positive and negative samples. To-be-processed images encountered by the identification model during actual use have various attack types, even a new attack type different from the negative sample in a training process. The identification model better distinguishes between the texture images of the positive and negative samples, so that when the identification model encounters a new attack type different from the negative sample, the identification model can distinguish that the new attack type is not an object type to be identified by the identification model, thereby improving a generalization capability of the identification model when facing various attack types.

A texture loss function that may measure generation precision of the texture image of the positive sample is generated by using the difference between the first texture image of the positive sample and the texture tag of the positive sample, and the initial identification model is trained by using both the asymmetric texture loss function and the identification loss function, so that the identification model obtained by training can better distinguish between the texture images of the positive and negative samples, thereby facilitating improving the generalization capability of the identification model when facing various attack types, and effectively improving identification precision of the identification model.

In some embodiments, the texture tag of the positive sample may be obtained in the following mode:
performing image texture conversion on the positive sample, to obtain the texture tag.

The texture tag is a texture image that is expected to be generated for the positive sample, i.e. a texture image that is expected by the server, can be generated by the initial identification model, and may fully reflect information of the positive sample in the texture dimension. During actual application, an image texture conversion operation may be directly performed on the positive sample, to obtain the corresponding texture tag. The image texture conversion operation is configured for performing texture conversion on the image, to obtain the texture image that may fully reflect the information of the positive sample in the texture dimension. The image texture conversion is directly performed on the positive sample, to reduce information loss caused by another operation as much as possible, and ensure reliability of the obtained texture tag. For example, grayscale processing may be directly performed on the positive sample image to obtain a corresponding grayscale map, where the grayscale map may be used as the texture tag.

The image texture conversion is performed on the positive sample, to obtain the texture tag that can fully reflect the information of the positive sample in the texture dimension, so that the texture tag may be used as a basis for calculating the texture loss function.

To further improve identification accuracy of the identification model, in addition to the texture loss function, another type of loss function may further be introduced to train the initial identification model together with the identification loss function. In some embodiments, the first image sample includes a positive sample and a negative sample, an identification tag of the positive sample identifies that an object in the positive sample belongs to a true object type, and an identification tag of the negative sample identifies that an object in the negative sample belongs to a false object type. The method further includes the following operations.

The server inputs the positive sample and the negative sample to the initial encoder, to obtain a first to-be-determined feature of the positive sample and a second to-be-determined feature of the negative sample.

The server generates a distance loss function based on a first difference between the first to-be-determined feature and an anchor feature and a second difference between the second to-be-determined feature and the anchor feature, where the anchor feature is determined based on the positive sample.

The operation in S206 that the server trains the initial identification model by using the identification loss function to obtain an identification model may include the following operations.

The server trains the initial identification model by using the identification loss function and the distance loss function, to obtain an updated identification model, where the initial identification model is trained by using the distance loss function based on an optimization target of minimizing the first difference and maximizing the second difference.

To reduce the false detection probability and the false identification rate of the identification model, the first image sample includes a positive sample and a negative sample. The positive sample is a first image sample in which an object included in the sample is a true object type, the negative sample is a first image sample in which an object included in the sample is a false object type, and the positive and negative samples participate in training of the initial identification model.

The to-be-determined feature is feature information obtained by the server from the first image sample by using the initial encoder. The first to-be-determined feature is a to-be-determined feature obtained from the positive sample by using the initial encoder. The second to-be-determined feature is a to-be-determined feature obtained from the negative sample by using the initial encoder. Since objects included in the positive sample all belong to a true object type, a distribution difference of the first to-be-determined feature corresponding to the positive sample may be relatively small. To be specific, a distribution of the first to-be-determined feature in the feature space may be relatively compact. Generally, there are various collection modes of the negative sample. For example, when the identification model identifies a living body, the negative sample includes various attack modes such as a video screenshot and a photo. To be specific, it is usually difficult to cluster the second to-be-determined features corresponding to the negative sample together. In addition, object types of objects included in the positive sample and the negative sample are different. To be specific, the first to-be-determined feature corresponding to the positive sample and the second to-be-determined feature corresponding to the negative sample have different parts. However, the positive sample and the negative sample may have similar parts in aspects such as a scene environment. For example, when the positive sample and the negative sample are obtained by using the same acquisition device indoors, the positive sample and the negative sample have similar features at least in aspects of parameters of the acquisition device. To be specific, boundaries of the first to-be-determined feature and the second to-be-determined feature in the feature space are unclear. In this case, if the feature distribution of the positive sample may be further gathered and the feature distributions of the positive sample and the negative sample may be pulled apart, to generate a feature space that is more discriminative and distinctive, helping to improve the generalization capability of the identification model when facing various attack types.

In view of this, the server may generate an asymmetric distance loss function based on the first difference between the first to-be-determined feature and an anchor feature and the second difference between the second to-be-determined feature and the anchor feature. The anchor feature is feature information obtained from a sample used as an anchor. In some embodiments, it is expected that the feature distribution of the positive sample can be gathered and the feature distributions of the positive samples and the negative samples can be pulled apart. Therefore, in some embodiments, the anchor is determined from the positive sample. The anchor may be randomly selected from the positive sample, and correspondingly, may be determined according to feature information of the positive samples used as the anchor (for example, feature information extracted by the initial encoder from the positive sample). For example, mean pooling processing may be performed on the feature information of the positive sample used as the anchor, to obtain corresponding anchor features. The first difference is a difference between the first to-be-determined feature corresponding to the positive sample and the anchor feature, and is a distance between the first to-be-determined feature and the anchor feature in the feature space. The second difference is a difference between the second to-be-determined feature corresponding to the negative sample and the anchor feature, and is a distance between the second to-be-determined feature and the anchor feature in the feature space. In some embodiments, the foregoing difference may be measured by using a suitable distance such as a Euclidean distance or a cosine distance. The server may generate, based on the first difference and the second difference, a distance loss function for comprehensively evaluating the first difference and the second difference. For example, when a to-be-determined feature f is a feature vector outputted by the initial encoder and subjected to global average pooling, the distance loss function may be determined by using the following formula:

$${L}_{W T} = δ ( {\sum }_{{f}_{p}} {w}_{p} d ( {f}_{a} , {f}_{p} ) - {\sum }_{{f}_{n}} {w}_{n} d ( {f}_{a} , {f}_{n} ) )$$

$${w}_{p} = Softmax d ( {f}_{a} , {f}_{p} ) )$$

$${w}_{n} = Softmax ( - d ( {f}_{a} , {f}_{n} ) )$$

where L_{WT} represents the distance loss function, δ represents a softplus function, fₐ, fₚ, fₙ represent the anchor feature, the first to-be-determined feature, and the second to-be-determined feature, d( [symbol] ) is a distance measure, d(fₐ, fₚ) represents the first difference, d(fₐ, fₙ) represents the second difference, wₚ, wₙ represent a weighting parameter of the first difference and a weighting parameter of the second difference, and Softmax represents the normalization function.

By using the foregoing formula, the distance between the anchor feature and the first to-be-determined feature in the feature space is used as a first difference, and the distance between the anchor feature and the second to-be-determined feature in the feature space is used as a second difference. Since a weighting parameter is configured for normalizing the first difference or the second difference, the corresponding weighting parameters are added to the first difference and the second difference, to dynamically allocate more importance to the sample. A difference between the weighted first differences corresponding to all the positive samples and the weighted second differences corresponding to all the negative samples is obtained, and a distance loss function may be obtained by processing the softplus function. When a value of the distance loss function outputted by the softplus function is close to zero, a difference generated by the weighted first differences corresponding to all the positive samples and the weighted second differences corresponding to all the negative samples is a relatively large negative number. To be specific, the weighted first difference is close to zero and the weighted second difference is a relatively large positive number. This indicates that a difference between the first to-be-determined feature and the anchor feature is very small and a difference between the second to-be-determined feature and the anchor feature is very large. To be specific, a distance between the positive sample and the anchor is very small and a distance between the negative sample and the anchor is very large.

After obtaining the distance loss function, the server may train the initial identification model by using the identification loss function and the distance loss function together, and in a training process, based on an optimization target of minimizing the first difference and maximizing the second difference, the feature distribution of the positive sample is gathered and the feature distributions of the positive sample and the negative sample are pulled apart by reducing the first difference between the first to-be-determined feature and the anchor feature and increasing the second difference between the second to-be-determined feature and the anchor feature.

In some embodiments, the feature distribution of the negative sample is not required to be gathered. This is because attack types in the negative sample are not completely the same, and it is difficult to gather the feature distributions of negative samples having different feature distributions. In addition, for negative samples including various false object types, determining a common feature distribution region also affects identification accuracy of a trained identification model for various attack types during actual use. Therefore, the feature distribution of the positive sample is gathered, and the feature distributions of the positive sample and the negative sample are pulled apart, so that a clearer boundary is generated for the feature distribution of the positive sample and the feature distribution of the negative sample in the feature space, thereby effectively improving identification precision of the identification model.

An asymmetric distance loss function may be generated according to a first difference between a first to-be-determined feature of the positive sample and an anchor feature determined based on the positive sample, a second to-be-determined feature of the negative sample and a second difference of the anchor feature. Further, the initial identification model is trained by using the distance loss function and the identification loss function together, and in a training process, the first difference is minimized and the second difference is maximized by using the distance loss function, to gather the feature distribution of the positive sample, and pull apart the feature distributions of the positive sample and the negative sample, thereby obtaining a feature space that is more discriminative and distinctive, helping to improve a generalization capability of the identification model when facing various attack types, thereby effectively improving identification precision of the identification model.

In some embodiments, the initial encoder further includes a plurality of network layers in addition to an input layer, and the first to-be-determined feature and the second to-be-determined feature are output features of a target network layer in the initial encoder. When the target network layer is an output layer of the initial encoder, the first to-be-determined feature is a first image sample feature of the positive sample and the second to-be-determined feature is a first image sample feature of the negative sample.

In some embodiments, in addition to the input layer, the initial encoder may include a plurality of network layers. Based on the positive sample or the negative sample inputted through the input layer, any of the plurality of network layers may determine corresponding output features for the positive sample and the negative sample. Since scales of the output features between different layers in the plurality of network layers are different, output features of any network layer (i.e. the target network layer) for the positive sample and the negative sample may be used as the first to-be-determined feature and the second to-be-determined feature according to a requirement for model training, so as to generate a distance loss function corresponding to the layer, where When an output layer in the plurality of network layers generates first image sample features respectively corresponding to the positive sample and the negative sample, the first image sample features generated by the output layer for the positive sample and the negative sample may be directly used as the first to-be-determined feature and the second to-be-determined feature, so as to generate a distance loss function corresponding to the output layer. Even to better train and optimize the initial encoder, the distance loss function may be determined according to an output feature of each of the plurality of network layers, to train and optimize output features of different scales outputted by each layer in the initial encoder.

The corresponding distance loss function may be determined for any one of a plurality of network layers of the initial encoder, so that a to-be-trained and optimized network layer may be accurately optimized according to a model training requirement, and each layer in the initial encoder may even be trained and optimized, to better improve performance of a trained identification model.

To further improve identification accuracy of the identification model, in addition to the texture loss function and the distance loss function, another type of loss function may further be introduced to train the initial identification model together with the identification loss function. In some embodiments, the first image sample includes a positive sample and a negative sample, an identification tag of the positive sample identifies that an object in the positive sample belongs to a true object type, and an identification tag of the negative sample identifies that an object in the negative sample belongs to a false object type. The method further includes the following operations.

The server generates a calibration loss function based on a feature similarity between the first image sample feature of the positive sample and a second image sample feature corresponding to the positive sample. The second image sample feature corresponding to the positive sample is a second image sample feature generated based on the first image sample feature of the positive sample.

The operation in S206 that the server trains the initial identification model by using the identification loss function to obtain an updated identification model may include the following operations.

The server trains the initial identification model by using the identification loss function and the calibration loss function, to obtain an updated identification model, where the initial identification model is trained by using the calibration loss function based on an optimization target of fixing the first image sample feature of the positive sample.

To reduce the false detection probability and the false identification rate of the identification model, the first image sample includes a positive sample and a negative sample. The positive sample is an image sample in which an object included in the sample is a true object type, the negative sample is an image sample in which an object included in the sample is a false object type, and the positive and negative samples participate in training of the initial identification model.

In S202, the server generates, based on the first image sample feature, second image sample features corresponding to different scene parameters. The first image sample feature and the second image sample feature are configured for training the initial identification model, so that the initial identification model may learn a capability of identifying the same object in different scene environments in a training process. During actual application of an identification model, various object type identification environments are encountered. Therefore, if an initial identification model can learn an invariant feature related to a true object type in a positive sample in a training process, the model may identify, in an actual application process, for a to-be-processed image including the true object type. According to the invariant feature, no matter how a scene environment included in the to-be-processed image changes, an object included in the to-be-processed image is the true object type, which is beneficial to improving a generalization capability of the identification model when facing various identification environments.

In view of this, the server may use the first image sample feature of the positive sample as a scale, to reduce a difference between the second image sample feature corresponding to the second image sample and the first image sample feature, so as to facilitate the initial identification model to learn the invariant feature from the first image sample feature and the second image sample feature that have a relatively small difference. In some embodiments, the server may generate a calibration loss function based on a feature similarity between the first image sample feature and the second image sample feature. The feature similarity is configured for representing a similarity degree between different image samples in a dimension of image features. The feature similarity may be represented by a distance between image features in a feature space. For example, suitable distance measures such as a Euclidean distance and a cosine distance may be configured for representing the feature similarity. The generated calibration loss function may reduce a difference between the second image sample feature and the first image sample feature during training of the initial identification model. For example, when the identification model identifies a living body, for a second image sample feature f_{syn}^{live} corresponding to a first image sample feature f^{live} corresponding to the positive sample, the calibration loss function may be determined by using the following formula:

L_{Cal}=d( [symbol] f^{live} [symbol] , f_{syn}^{live})
where L_{Cal} represents the calibration loss function, f^{live} represents the first image sample feature of the positive sample, f_{syn}^{live} represents the second image sample feature of the cross-scene image sample corresponding to the positive sample, [symbol] ⋅ [symbol] represents a gradient stop operation, and d( [symbol] ) is a distance measure.

By using the foregoing formula, a gradient stop operation may be performed on the first image sample feature, to fix the first image sample feature unchanged. To be specific, the first image sample feature is used as a scale. When the value of the calibration loss function value is close to zero, it indicates that the similarity between the second image sample feature and the fixed first image sample feature is relatively high.

After obtaining the calibration loss function, the server may train the initial identification model by using the identification loss function and the calibration loss function together. In addition, the first image sample feature is fixed in a training process. A difference between the second image sample feature corresponding to the positive sample and the first image sample feature of the positive sample is reduced by using the calibration loss function, so that the second image sample feature generated based on the first image sample feature can keep, to the greatest extent, the invariant feature related to identifying the true object type in the first image sample feature, thereby further improving the precision of cross-scene sample augmentation, so that the initial identification model can learn the invariant feature in the training process.

In some embodiments, a calibration loss function is not generated for the negative sample since attack types of the negative sample are diversified. Different attack types correspond to different invariant features related to identifying a false object type, and it is difficult for the initial identification model to learn the invariant feature related to identifying the false object type in a training process. In addition, when facing various attack types encountered by the model during actual application, if the initial identification model relatively well learns the invariant feature related to identifying a true object type in an actual application process, the obtained identification model may accurately identify the true object type in an actual use process,

A calibration loss function may be generated according to a feature similarity of the first image sample feature of the positive sample and the corresponding second image sample feature, and the initial identification model is trained by using the calibration loss function and the identification loss function together. In a training process, the first image sample feature is used as a scale, to reduce a difference between the second image sample feature and the first image sample feature, so that the second image sample feature generated based on the first image sample feature can keep, to the greatest extent, the invariant feature related to identifying the true object type in the first image sample feature, thereby improving the precision of cross-scene sample augmentation, so that the initial identification model can learn the invariant feature in the training process, thereby facilitating improving a generalization capability of the identification model when facing various identification environments, and effectively improving identification accuracy of the identification model.

To further improve identification accuracy of the identification model, in some embodiments, the identification loss function, the texture loss function, the distance loss function, and the calibration loss function may be used together to train the initial identification model. As shown in FIG. 6A, in a training process, first image sample features corresponding to a positive sample and a negative sample are first obtained by the initial encoder E, where the distance loss function may be applied to each layer of the initial encoder E. Second, a second image sample feature may be generated based on the first image sample feature, thereby implementing cross-scene conversion of the first image sample. After the second image sample feature is obtained, on one hand, a corresponding first texture image and second texture image may be generated according to the first image sample feature and the second image sample feature by the initial decoder D, where a texture loss function for model training may be generated based on the first texture image of the positive sample. On the other hand, the initial feature embedding module B may generate a first embedded feature and a second embedded feature according to the first image sample feature and the second image sample feature. Then, information complementation is performed on the texture image and the embedded feature by using an attention mechanism, where image regions of an image sample may be divided to enhance details. Next, by using a first embedded feature of the positive sample as a scale, a difference between the first embedded feature and a second embedded feature of a cross-scene image sample corresponding to the positive sample may be reduced through the calibration loss function. Finally, a corresponding category identification result is obtained by using the initial classifier based on the embedded feature and the texture image, and the identification loss function for model training is obtained according to the category identification result and the identification tag.

In a training process, the server may obtain a total loss function for model training by combining the identification loss function, the texture loss function, the distance loss function, and the calibration loss function. For example, the total loss function may be obtained by using the following formula:

$$L = {L}_{C E} + {λ}_{A E} {L}_{A E} + {λ}_{W T} {L}_{W T} + {λ}_{C a l} {L}_{C a l}$$

where L_{CE} represents the identification loss function, L_{AE} represents the texture loss function, L_{WT} represents the distance loss function, L_{Cal} represents the calibration loss function, and λ_{AE}, λ_{WT}, λ_{Cal} are weights corresponding to the texture loss function, the distance loss function, and the calibration loss function.

By using the foregoing formula, a total loss function may be obtained by using the identification loss function, the texture loss function, the distance loss function, and the calibration loss function, and the initial identification model is trained by using the total loss function, to obtain an identification model that can have a better generalization capability for cross-scene identification and identification of various attack types.

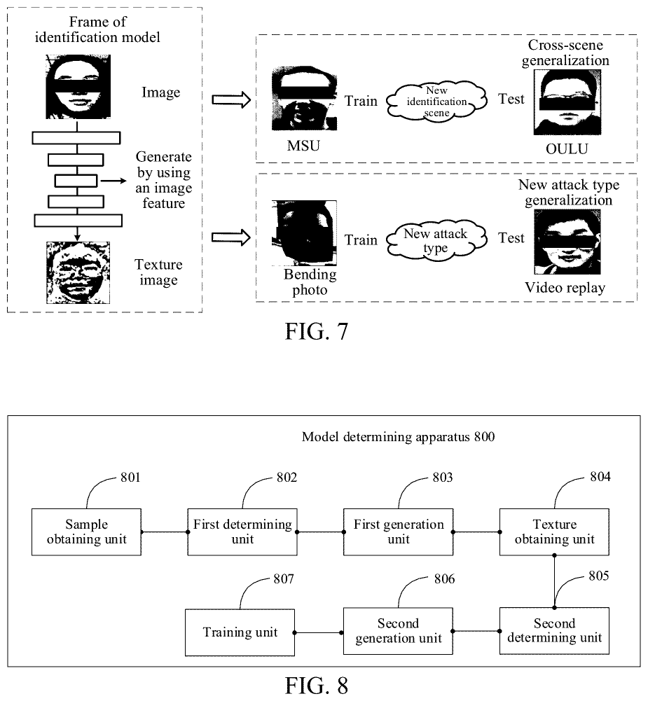

As shown in FIG. 7, a frame of an identification model having a generalization capability generates a corresponding texture image for an inputted image instead of directly performing identification and detection on the image. The texture image of the reconstructed image may help the model to identify an object in the image both in a feature dimension and a texture image dimension, and the obtained identification model has a relatively high generalization capability facing cross-scene identification and a new attack type. To verify the generalization capability of the identification model, the server may test the identification model by using a new identification scene and a new attack type that are different from those during training. In some embodiments, when the initial identification model is trained using samples in an MSU database, the obtained identification model may be tested using samples in an OULU database, where image samples in the MSU database and image samples in the OULU database have different identification scenes. When the initial identification model is trained by using a bending photo attack means, the obtained identification model may be tested by using a video replay attack means. The identification model obtained in some embodiments has a good result in a test of a new identification scene and a new attack type, indicating that the identification model obtained in some embodiments has a better generalization capability in cross-scene and new attack types.

Based on the foregoing embodiments corresponding to FIGS. 1-7, FIG. 8 is a schematic diagram of a model determining apparatus according to some embodiments. The model determining apparatus 800 includes a sample obtaining unit 801, a first determining unit 802, a first generation unit 803, a texture obtaining unit 804, a second determining unit 805, a second generation unit 806, and a training unit 807.

The sample obtaining unit 801 is configured to obtain a first image sample, where the first image sample has an identification tag identifying an object type to which an object in the first image sample belongs.

The first determining unit 802 is configured to input the first image sample to an initial encoder of an initial identification model, to obtain a first image sample feature of the first image sample, where the initial identification model further includes an initial decoder and an initial classifier.

The first generation unit 803 is configured to generate a second image sample feature based on the first image sample feature, where the second image sample feature and the first image sample feature have different scene parameter values and correspond to the same identification tag.

The texture obtaining unit 804 is configured to input the first image sample feature and the second image sample feature to the initial decoder, to obtain a first texture image corresponding to the first image sample feature and a second texture image corresponding to the second image sample feature.

The second determining unit 805 is configured to input the first image sample feature and the first texture image to the initial classifier to obtain a first prediction result of the object type, and input the second image sample feature and the second texture image to the initial classifier to obtain a second prediction result of the object type.

The second generation unit 806 is configured to generate an identification loss function based on a difference between each of the first prediction result and the second prediction result and the identification tag.

The training unit 807 is configured to train the initial identification model by using the identification loss function, to obtain an updated identification model.

In some embodiments, when the first image sample includes a positive sample and an identification tag of the positive sample identifies that an object in the positive sample belongs to a true object type, the second generation unit 806 is further configured to generate a texture loss function based on a difference between a first texture image of the positive sample and a texture tag of the positive sample. The first texture image corresponding to the positive sample is obtained by inputting the first image sample feature of the positive sample to the initial decoder.

The training unit 806 is configured to train the initial identification model by using the identification loss function and the texture loss function, to obtain the updated identification model.

In some embodiments, the texture obtaining unit 804 is further configured to perform image texture conversion on the positive sample, to obtain the texture tag.

In some embodiments, the second determining unit 805 is configured to:
map the first image sample feature to a feature space of the first texture image, to obtain a mapped sample feature;
determine a sample attention map based on feature distributions of the mapped sample feature and the first texture image for the same image region, where the sample attention map is configured for identifying an attention weight corresponding to an image region in the first image sample in an object type identification task;
generate an attention sample feature according to the mapped sample feature and the sample attention map, and generate an attention texture image according to the first texture image and the sample attention map; and
input the attention sample feature and the attention texture image to the initial classifier, and determine the first prediction result.

In some embodiments, the model determining apparatus 800 further includes a division unit, configured to divide the first image sample into N sub-image regions, where N is an integer greater than 1.

The second determining unit 805 is configured to:
determine, according to the first image sample feature, N sub-features corresponding to the N sub-image regions, and map the N sub-features to the feature space of the first texture image, to obtain N sub-mapped features forming the mapped sample feature;
obtain, for an i^{th} sub-image region in the N sub-image regions (i is an integer greater than or equal to 1 and less than or equal to N), an i^{th} sub-mapped feature corresponding to the i^{th} sub-image region in the mapped sample features, and an i^{th} texture grid corresponding to the i^{th} sub-image region in the first texture image; and
determine, according to feature distributions of the i^{th} sub-mapped feature and the i^{th} texture grid, a sub-attention map corresponding to the i^{th} sub-image region in the sample attention map.

In some embodiments, when the first image sample includes a positive sample and a negative sample, an identification tag of the positive sample identifies that an object in the positive sample belongs to a true object type, and an identification tag of the negative sample identifies that an object in the negative sample belongs to a false object type, the second generation unit 806 is further configured to:
input the positive sample and the negative sample to the initial encoder, to obtain a first to-be-determined feature of the positive sample and a second to-be-determined feature of the negative sample; and
generate a distance loss function based on a first difference between the first to-be-determined feature and an anchor feature and a second difference between the second to-be-determined feature and the anchor feature, where the anchor feature is determined based on the positive sample.

The training unit 807 is configured to train the initial identification model by using the identification loss function and the distance loss function, to obtain the updated identification model. The initial identification model is trained by using the distance loss function based on an optimization target of minimizing the first difference and maximizing the second difference.

In some embodiments, the initial encoder further includes a plurality of network layers in addition to an input layer, and the first to-be-determined feature and the second to-be-determined feature are output features of a target network layer in the initial encoder. When the target network layer is an output layer of the initial encoder, the first to-be-determined feature is a first image sample feature of the positive sample and the second to-be-determined feature is a first image sample feature of the negative sample.

In some embodiments, the first generation unit 803 is configured to perform the following operations.

In M first image samples in one round of training the initial identification model, M is an integer greater than 1. For a j^{th} image sample in the M first image samples, j is an integer greater than or equal to 1 and less than or equal to M. The first generation unit 803 is configured to:
determine, for each other first image sample than the j^{th} first image sample in the M first image samples, a feature similarity between the j^{th} first image sample and the other first image samples on the first image sample feature;
determine other first image samples having corresponding feature similarities less than a similarity threshold as difference samples; and
generate a second image sample feature of the j^{th} first image sample according to the first image sample feature of the difference sample and the first image sample feature of the j^{th} first image sample.

In some embodiments, the first generation unit 803 is configured to:
generate an initial second image sample feature according to the first image sample feature of the difference sample and the first image sample feature of the j^{th} first image sample; and
use the first image sample feature of the j^{th} first image sample as a mixing constraint, and mix the first image sample feature of the j^{th} first image sample and the initial second image sample feature, to obtain the second image sample feature of the j^{th} first image sample.

In some embodiments, when the first image sample includes a positive sample and a negative sample, an identification tag of the positive sample identifies that an object in the positive sample belongs to a true object type, and an identification tag of the negative sample identifies that an object in the negative sample belongs to a false object type, the second generation unit 806 is further configured to:
generate a calibration loss function based on a feature similarity between the first image sample feature of the positive sample and a second image sample feature corresponding to the positive sample. The second image sample feature corresponding to the positive sample is a second image sample feature generated based on the first image sample feature of the positive sample.

The training unit 807 is configured to train the initial identification model by using the identification loss function and the calibration loss function, to obtain the updated identification model. The initial identification model is trained by using the calibration loss function based on an optimization target of fixing the first image sample feature of the positive sample.

In some embodiments, when the initial identification model further includes an initial feature embedding module, the second determining unit 805 is configured to:
input the first image sample feature to the initial feature embedding module, to obtain a corresponding first embedded feature; and
input the first embedded feature and the first texture image to the initial classifier, to obtain the first prediction result.

According to some embodiments, each module in the apparatus may exist respectively or be combined into one or more units. Certain (or some) unit in the units may be further split into multiple smaller function subunits, thereby implementing the same operations without affecting the technical effects of some embodiments. The modules are divided based on logical functions. In actual applications, a function of one module may be realized by multiple units, or functions of multiple modules may be realized by one unit. In some embodiments, the apparatus may further include other units. In actual applications, these functions may also be realized cooperatively by the other units, and may be realized cooperatively by multiple units.

A person skilled in the art would understand that these “modules” and “units” could be implemented by hardware logic, a processor or processors executing computer software code, or a combination of both. The “modules” and “units” may also be implemented in software stored in a memory of a computer or a non-transitory computer-readable medium, where the instructions of each module and unit are executable by a processor to thereby cause the processor to perform the respective operations of the corresponding module and unit.

Some embodiments further provide a computer device. The computer device is the computer device described above and may include a terminal device or a server. The model determining apparatus may be configured in the computer device. The following describes the computer device with reference to the accompanying drawings.

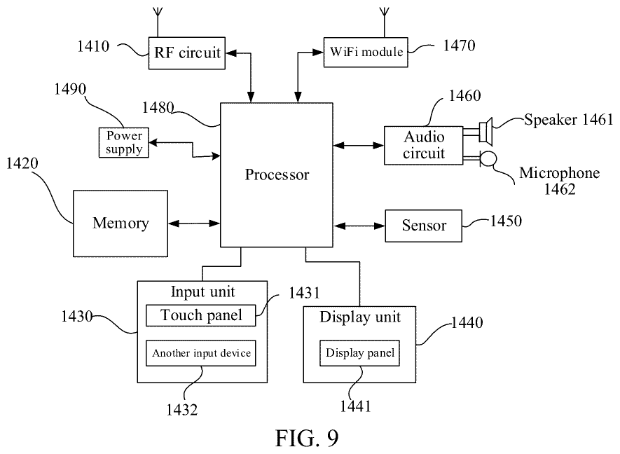

If the computer device is a terminal device, refer to FIG. 9. Some embodiments provide a terminal device. An example in which the terminal device is a mobile phone is used:

FIG. 9 shows a block diagram of a structure of a part of a mobile phone related to a terminal device according to some embodiments. Referring to FIG. 9, the mobile phone includes: a radio frequency (RF) circuit 1410, a memory 1420, an input unit 1430, a display unit 1440, a sensor 1450, an audio circuit 1460, a wireless fidelity (WiFi) module 1470, a processor 1480, a power supply 1490, and other components. A person skilled in the art may understand that the structure, shown in FIG. 9, of the mobile phone does not constitute a limitation on the mobile phone, and the mobile phone may include more or fewer components than those shown in the figure, or a combination of some components, or a different component deployment may be used.

The following describes the components of the mobile phone with reference to FIG. 9.

The RF circuit 1410 may be configured to receive and transmit a signal during information reception and transmission or calling. Particularly, after receiving downlink information from a base station, the information is transmitted to the processor 1480 for processing. In addition, designed uplink data is transmitted to the base station.

The memory 1420 may be configured to store a software program and a module. The processor 1480 runs the software program and the module that are stored in the memory 1420, to perform various functional applications and data processing of the mobile phone. The memory 1420 may mainly include a program storage region and a data storage region. The program storage region may store an operating system, an application required for at least one function (for example, a sound playback function and an image playback function), and the like. The data storage region may store data (for example, audio data and a phone book) created based on use of the mobile phone and the like. In addition, the memory 1420 may include a high speed random access memory, and may include a non-volatile memory, such as at least one magnetic disk storage device, a flash memory, or another volatile solid-state storage device.

The input unit 1430 may be configured to receive input digit or character information, and generate a keyboard signal input related to user settings and function control of the mobile phone. In some embodiments, the input unit 1430 may include a touch panel 1431 and another input device 1432.

The display unit 1440 may be configured to display information inputted by a user or information provided for the user, and various menus of the mobile phone. The display unit 1440 may include a display panel 1441.

The mobile phone may further include at least one sensor 1450 such as an optical sensor, a motion sensor, and other sensors.

The audio circuit 1460, a speaker 1461, and a microphone 1462 may provide audio interfaces between the user and the mobile phone.

WiFi is a short-distance wireless transmission technology. The mobile phone may help, by using the WiFi module 1470, the user to receive and transmit an email, browse a web page, access stream media, and the like, to allow wireless broadband Internet access of the user.

The processor 1480 is a control center of the mobile phone, and is connected to various parts of the entire mobile phone via various interfaces and lines. Various functions of the mobile phone and data processing are performed by running or executing the software program and/or the module stored in the memory 1420 and invoking data stored in the memory 1420.

The mobile phone further includes the power supply 1490 (such as a battery) for supplying power to the components.

In some embodiments, the processor 1480 included in the terminal device is further configured to perform the model determining method provided in some embodiments.

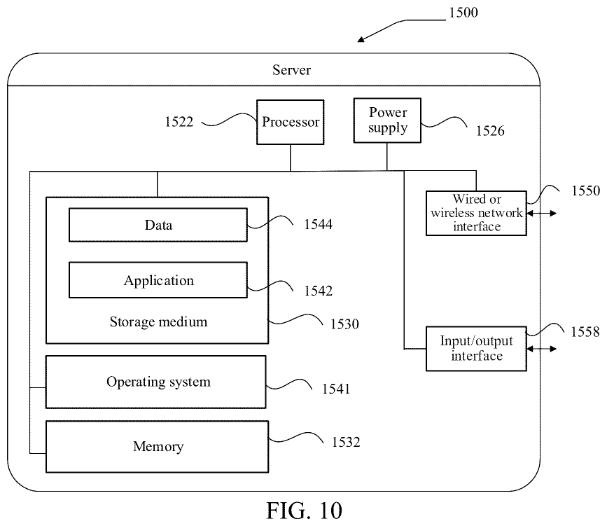

FIG. 10 is a structural diagram of a server 1500 according to some embodiments. The server 1500 greatly differs due to different configurations or performances. The server may include one or more central processing units (CPU) 1522 (for example, one or more processors), a memory 1532, and one or more storage media 1530 (for example, one or more mass storage devices) for storing applications 1542 or data 1544. The memory 1532 and the storage medium 1530 may be configured for temporary storage or persistent storage. A program stored in the storage medium 1530 may include one or more modules (not shown). Each module may include a series of instruction operations on the server. Furthermore, the CPU 1522 may be configured to communicate with the storage medium 1530, and perform, on the server 1500, the series of instruction operations on the storage medium 1530.

The server 1500 may further include one or more power supplies 1526, one or more wired or wireless network interfaces 1550, one or more input/output interfaces 1558, and/or one or more operating systems 1541 such as Windows Server™, Mac OS X™, Unix™, Linux™, or FreeBSD™.

Operations performed by the server in the foregoing embodiments may be based on the server structure shown in FIG. 10.

In addition, some embodiments further provide a storage medium. The storage medium is configured to store a computer program. The computer program is configured for performing the method provided in the foregoing embodiments.

Some embodiments further provide a computer program product including a computer program. The computer program, when run on a computer device, causes the computer device to perform the method provided in the foregoing embodiments.

A person of ordinary skill in the art may understand that all or some operations for implementing the foregoing method embodiments may be completed by a program instructing related hardware, the foregoing program may be stored in a computer-readable storage medium, and the program, when executed, performs operations including the foregoing method embodiments. The foregoing storage medium may be at least one of the following media: a read-only memory (ROM), a RAM, a magnetic disk or an optical disc, or various media capable of storing a computer program.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A model determining method, performed by a computer device, comprising:
obtaining a first image sample, the first image sample having an identification tag identifying an object type to which an object in the first image sample belongs;
inputting the first image sample to an initial encoder of an initial identification model to obtain a first image sample feature of the first image sample, the initial identification model further comprising an initial decoder and an initial classifier;
generating a second image sample feature based on the first image sample feature, the second image sample feature and the first image sample feature having different scene parameter values and corresponding to the same identification tag;
separately inputting the first image sample feature and the second image sample feature to the initial decoder to obtain a first texture image corresponding to the first image sample feature and a second texture image corresponding to the second image sample feature;
inputting the first image sample feature and the first texture image to the initial classifier to obtain a first prediction result of the object type, and inputting the second image sample feature and the second texture image to the initial classifier to obtain a second prediction result of the object type;
generating an identification loss function based on a difference between each of the first prediction result and the second prediction result and the identification tag; and
training the initial identification model by using the identification loss function to obtain an updated identification model.

2. The model determining method according to claim 1, wherein the first image sample comprises a positive sample, and an identification tag of the positive sample identifies that an object in the positive sample belongs to a true object type;
wherein the model determining method further comprises:
generating a texture loss function based on a difference between a first texture image corresponding to the positive sample and a texture tag of the positive sample, the first texture image corresponding to the positive sample being obtained by inputting a first image sample feature of the positive sample to the initial decoder; and
wherein the training comprises:
training the initial identification model by using the identification loss function and the texture loss function, to obtain the updated identification model.

3. The model determining method according to claim 2, further comprising:
performing image texture conversion on the positive sample to obtain the texture tag.

4. The model determining method according to claim 1, wherein the inputting the first image sample feature and the first texture image to the initial classifier comprises:
mapping the first image sample feature to a feature space of the first texture image to obtain a mapped sample feature;
determining a sample attention map based on feature distributions of the mapped sample feature and the first texture image for the same image region, the sample attention map being configured for identifying an attention weight corresponding to an image region in the first image sample in an object type identification task;
generating an attention sample feature according to the mapped sample feature and the sample attention map, and generating an attention texture image according to the first texture image and the sample attention map; and
inputting the attention sample feature and the attention texture image to the initial classifier, and determining the first prediction result.

5. The model determining method according to claim 4, further comprising:
dividing the first image sample into N sub-image regions, N being an integer greater than 1,
wherein the mapping comprises:
determining, according to the first image sample feature, N sub-features corresponding to the N sub-image regions, and mapping the N sub-features to the feature space of the first texture image to obtain N sub-mapped features forming the mapped sample feature; and
for an i^{th} sub-image region in the N sub-image regions (i is an integer greater than or equal to 1 and less than or equal to N), the determining a sample attention map based on feature distributions of the mapped sample feature and the first texture image for the same image region comprises:
obtaining an i^{th} sub-mapped feature corresponding to the i^{th} sub-image region in the mapped sample feature, and an i^{th} texture grid corresponding to the i^{th} sub-image region in the first texture image; and
determining, according to feature distributions of the i^{th} sub-mapped feature and the i^{th} texture grid, a sub-attention map corresponding to the i^{th} sub-image region in the sample attention map.

6. The model determining method according to claim 1, wherein the first image sample comprises the positive sample and a negative sample, the identification tag of the positive sample identifies that the object in the positive sample belongs to a true object type, and an identification tag of the negative sample identifies that an object in the negative sample belongs to a false object type;
wherein the model determining method further comprises:
separately inputting the positive sample and the negative sample to the initial encoder to obtain a first to-be-determined feature of the positive sample and a second to-be-determined feature of the negative sample; and
generating a distance loss function based on a first difference between the first to-be-determined feature and an anchor feature and a second difference between the second to-be-determined feature and the anchor feature, the anchor feature being determined based on the positive sample; and
wherein the training comprises:
training the initial identification model by using the identification loss function and the distance loss function to obtain the updated identification model, the initial identification model being trained by using the distance loss function based on an optimization target of minimizing the first difference and maximizing the second difference.

7. The model determining method according to claim 6, wherein the initial encoder further comprises a plurality of network layers in addition to an input layer, the first to-be-determined feature and the second to-be-determined feature are output features of a target network layer in the initial encoder, and when the target network layer is an output layer of the initial encoder, the first to-be-determined feature is the first image sample feature of the positive sample and the second to-be-determined feature is a first image sample feature of the negative sample.

8. The model determining method according to claim 1, wherein in M first image samples in one round of training the initial identification model, M is an integer greater than 1, for a j^{th} image sample in the M first image samples, j is an integer greater than or equal to 1 and less than or equal to M, and
wherein the generating a second image sample feature based on the first image sample feature comprises:
determining, for each other first image sample than the j^{th} first image sample in the M first image samples, a feature similarity between the j^{th} first image sample and the other first image samples on the first image sample feature;
determining other first image samples having corresponding feature similarities less than a similarity threshold as difference samples; and
generating a second image sample feature of the j^{th} first image sample according to a first image sample feature of the difference sample and a first image sample feature of the j^{th} first image sample.

9. The model determining method according to claim 8, wherein the generating a second image sample feature of the j^{th} first image sample according to the first image sample feature of the difference sample and the first image sample feature of the j^{th} first image sample comprises:
generating an initial second image sample feature according to the first image sample feature of the difference sample and the first image sample feature of the j^{th} first image sample; and
using the first image sample feature of the j^{th} first image sample as a mixing constraint, and mixing the first image sample feature of the j^{th} first image sample and the initial second image sample feature to obtain the second image sample feature of the j^{th} first image sample.

10. The model determining method according to claim 1, wherein the first image sample comprises the positive sample and the negative sample, the identification tag of the positive sample identifies that the object in the positive sample belongs to a true object type, and the identification tag of the negative sample identifies that the object in the negative sample belongs to a false object type;
wherein the model determining method further comprises:
generating a calibration loss function based on a feature similarity between the first image sample feature of the positive sample and a second image sample feature corresponding to the positive sample, the second image sample feature corresponding to the positive sample being a second image sample feature generated based on the first image sample feature of the positive sample; and
wherein the training comprises:
training the initial identification model by using the identification loss function and the calibration loss function to obtain the updated identification model, the initial identification model being trained by using the calibration loss function based on an optimization target of fixing the first image sample feature of the positive sample.

11. The model determining method according to claim 1, wherein the initial identification model further comprises an initial feature embedding module, and
wherein the inputting the first image sample feature and the first texture image to the initial classifier comprises:
inputting the first image sample feature to the initial feature embedding module to obtain a corresponding first embedded feature; and
inputting the first embedded feature and the first texture image to the initial classifier to obtain the first prediction result.

12. A model determining apparatus comprising:
at least one memory configured to store computer program code; and
at least one processor configured to read the program code and operate as instructed by the program code, the program code comprising:
sample obtaining code configured to cause at least one of the at least one processor to obtain a first image sample, the first image sample having an identification tag identifying an object type to which an object in the first image sample belongs;
first determining code configured to cause at least one of the at least one processor to input the first image sample to an initial encoder of an initial identification model to obtain a first image sample feature of the first image sample, the initial identification model further comprising an initial decoder and an initial classifier;
first generation code configured to cause at least one of the at least one processor to generate a second image sample feature based on the first image sample feature, the second image sample feature and the first image sample feature having different scene parameter values and corresponding to the same identification tag;
texture obtaining code configured to cause at least one of the at least one processor to separately input the first image sample feature and the second image sample feature to the initial decoder to obtain a first texture image corresponding to the first image sample feature and a second texture image corresponding to the second image sample feature;
second determining code configured to cause at least one of the at least one processor to input the first image sample feature and the first texture image to the initial classifier to obtain a first prediction result of the object type, and input the second image sample feature and the second texture image to the initial classifier to obtain a second prediction result of the object type;
second generation code configured to cause at least one of the at least one processor to generate an identification loss function based on a difference between each of the first prediction result and the second prediction result and the identification tag; and
training code configured to train the initial identification model by using the identification loss function to obtain an updated identification model.

13. The model determining apparatus according to claim 12, wherein the first image sample comprises a positive sample, and an identification tag of the positive sample identifies that an object in the positive sample belongs to a true object type;
wherein the second generation code is further configured to cause at least one of the at least one processor to:
generate a texture loss function based on a difference between a first texture image corresponding to the positive sample and a texture tag of the positive sample, the first texture image corresponding to the positive sample being obtained by inputting a first image sample feature of the positive sample to the initial decoder; and
wherein the training code is further configured to cause at least one of the at least one processor to:
train the initial identification model by using the identification loss function and the texture loss function to obtain the updated identification model.

14. The model determining apparatus according to claim 13, wherein texture obtaining code is further configured to cause at least one of the at least one processor to:
perform image texture conversion on the positive sample to obtain the texture tag.

15. The model determining apparatus according to claim 12, wherein the second determining code is further configured to cause at least one of the at least one processor to:
map the first image sample feature to a feature space of the first texture image to obtain a mapped sample feature;
determine a sample attention map based on feature distributions of the mapped sample feature and the first texture image for the same image region, the sample attention map being configured for identifying an attention weight corresponding to an image region in the first image sample in an object type identification task;
generate an attention sample feature according to the mapped sample feature and the sample attention map, and generate an attention texture image according to the first texture image and the sample attention map; and
input the attention sample feature and the attention texture image to the initial classifier, and determine the first prediction result.

16. The model determining apparatus according to claim 15, wherein the program code further comprises division code configured to cause at least one of the at least one processor to divide the first image sample into N sub-image regions, N being an integer greater than 1,
wherein the second determining code is further configured to cause at least one of the at least one processor to:
determine, according to the first image sample feature, N sub-features corresponding to the N sub-image regions, and map the N sub-features to the feature space of the first texture image to obtain N sub-mapped features forming the mapped sample feature;
obtain, for an i^{th} sub-image region in the N sub-image regions, an i^{th} sub-mapped feature corresponding to the i^{th} sub-image region in the mapped sample feature, and an i^{th} texture grid corresponding to the i^{th} sub-image region in the first texture image; and
determine, according to feature distributions of the i^{th} sub-mapped feature and the i^{th} texture grid, a sub-attention map corresponding to the i^{th} sub-image region in the sample attention map.

17. The model determining apparatus according to claim 12, wherein the first image sample comprises the positive sample and a negative sample, the identification tag of the positive sample identifies that the object in the positive sample belongs to a true object type, and an identification tag of the negative sample identifies that an object in the negative sample belongs to a false object type;
wherein the second generation code is further configured to cause at least one of the at least one processor to:
separately input the positive sample and the negative sample to the initial encoder to obtain a first to-be-determined feature of the positive sample and a second to-be-determined feature of the negative sample; and
generate a distance loss function based on a first difference between the first to-be-determined feature and an anchor feature and a second difference between the second to-be-determined feature and the anchor feature, the anchor feature being determined based on the positive sample; and
wherein the training code is further configured to cause at least one of the at least one processor to:
train the initial identification model by using the identification loss function and the distance loss function to obtain the updated identification model, the initial identification model being trained by using the distance loss function based on an optimization target of minimizing the first difference and maximizing the second difference.

18. The model determining apparatus according to claim 17, wherein the initial encoder further comprises a plurality of network layers in addition to an input layer, the first to-be-determined feature and the second to-be-determined feature are output features of a target network layer in the initial encoder, and when the target network layer is an output layer of the initial encoder, the first to-be-determined feature is the first image sample feature of the positive sample and the second to-be-determined feature is a first image sample feature of the negative sample.

19. The model determining apparatus according to claim 12, wherein in M first image samples in one round of training the initial identification model, M is an integer greater than 1, for a j^{th} image sample in the M first image samples, j is an integer greater than or equal to 1 and less than or equal to M, and
wherein the first generation code is further configured to cause at least one of the at least one processor to:
determine, for each other first image sample than the j^{th} first image sample in the M first image samples, a feature similarity between the j^{th} first image sample and the other first image samples on the first image sample feature;
determine other first image samples having corresponding feature similarities less than a similarity threshold as difference samples; and
generate a second image sample feature of the j^{th} first image sample according to a first image sample feature of the difference sample and a first image sample feature of the j^{th} first image sample.

20. A non-transitory computer-readable storage medium, storing computer code which, when executed by at least one processor, causes the at least one processor to at least:
obtain a first image sample, the first image sample having an identification tag identifying an object type to which an object in the first image sample belongs;
input the first image sample to an initial encoder of an initial identification model to obtain a first image sample feature of the first image sample, the initial identification model further comprising an initial decoder and an initial classifier;
generate a second image sample feature based on the first image sample feature, the second image sample feature and the first image sample feature having different scene parameter values and corresponding to the same identification tag;
separately input the first image sample feature and the second image sample feature to the initial decoder to obtain a first texture image corresponding to the first image sample feature and a second texture image corresponding to the second image sample feature;
input the first image sample feature and the first texture image to the initial classifier to obtain a first prediction result of the object type, and input the second image sample feature and the second texture image to the initial classifier to obtain a second prediction result of the object type;
generate an identification loss function based on a difference between each of the first prediction result and the second prediction result and the identification tag; and
train the initial identification model by using the identification loss function to obtain an updated identification model.
